(19) United States
(12) Patent Application Publication
(10) Pub. No.: US 2026/0188330 A1
(43) Pub. Date: Jul. 2, 2026

(54) DETERMINING FREQUENCY SUB BANDS FOR SPATIAL AUDIO PARAMETERS

(71) Applicant: NOKIA TECHNOLOGIES OY, Espoo (FI)

(72) Inventors: Adriana VASILACHE, Tampere (FI); Anssi Sakari RÄMÖ, Tampere (FI); Mikko-Ville LAITINEN, Espoo (FI); Lasse Juhani LAAKSONEN, Tampere (FI); Tapani PIHLAJAKUJA, Kellokoski (FI)

(21) Appl. No.: 19/130,984

(22) PCT Filed: Nov. 21, 2022
(86) PCT No.: PCT/EP2022/082578

§ 371 Date: May 19, 2025

(51) Int. Cl. G10L 19/008; G10L 19/02

(52) U.S. Cl. CPC G10L 19/008; G10L 19/0204

(57) ABSTRACT

There is inter alia disclosed an apparatus for spatial audio encoding which can receive a coding rate associated with one or more audio signals and map at least two consecutive sub bands of a plurality of frequency sub bands to a broadened frequency sub band to give a coding rate adjusted plurality of frequency sub bands. The apparatus can also receive a bandwidth value associated with the one or more audio signals and remove, starting from the highest frequency sub band of the coding rate adjusted plurality of frequency sub bands, a number of frequency sub bands to give a bandwidth adjusted plurality of frequency sub bands.

### FIELD

The present application relates to apparatus and methods for changing the bandwidth of a spatial audio signal.

### BACKGROUND

Immersive audio codecs are being implemented supporting a multitude of operating points ranging from a low bit rate operation to transparency. An example of such a codec is the Immersive Voice and Audio Services (IVAS) codec which is being designed to be suitable for use over a communications network such as a 3GPP 4G/5G network including use in such immersive services as for example immersive voice and audio for virtual reality (VR). This audio codec is expected to handle the encoding, decoding and rendering of speech, music and generic audio. It is furthermore expected to support channel-based audio and scene-based audio inputs including spatial information about the sound field and sound sources. The codec is also expected to operate with low latency to enable conversational services as well as support high error robustness under various transmission conditions.

Metadata-assisted spatial audio (MASA) is one input format for IVAS. It uses audio signal(s) together with corresponding spatial metadata. The spatial metadata comprises parameters which define the spatial aspects of the audio signals and which may contain for example, directions and direct-to-total energy ratios in frequency bands. The MASA stream can, for example, be obtained by capturing spatial audio with microphones of a suitable capture device. For example, a mobile device comprising multiple microphones may be configured to capture microphone signals where the set of spatial metadata can be estimated based on the captured microphone signals. The MASA stream can be obtained also from other sources, such as specific spatial audio microphones (such as Ambisonics or array-microphones), studio mixes (for example, a 5.1 audio channel mix) or other content by means of a suitable format conversion.

An audio signal input to an immersive voice codec (such as IVAS) can be simultaneously encoded as 1-N audio signals to give a transport audio stream and analysed to give a MASA metadata stream. In such a setup the analysis and encoding for the MASA metadata stream can be performed separately from the encoding for the transport audio stream. This can result in the needless encoding of some MASA metadata sets. Particularly for sub bands of the transport audio stream which have a minimum contribution to the overall synthesised spatial audio signal. Furthermore, this can lead to a mismatch between the bandwidth at which the input audio signal is being encoded for the transport audio stream and the bandwidth at which the input audio signal is analysed for the MASA metadata stream.

### SUMMARY

There is according to a first aspect an apparatus for spatial audio encoding comprising means configured to: determine a spatial audio parameter set for each of a plurality of frequency sub bands of the one or more audio signals; receive a coding rate associated with the one or more audio signals; map at least two consecutive sub bands of the plurality of frequency sub bands to a broadened frequency sub band to give a coding rate adjusted plurality of frequency sub bands based on the coding rate; receive a bandwidth value associated with the one or more audio signals; remove, starting from the highest frequency sub band of the coding rate adjusted plurality of frequency sub bands, a number of frequency sub bands to give a bandwidth adjusted plurality of frequency sub bands, wherein the number of frequency sub bands removed is based on the bandwidth value associated with the one or more audio signals; on condition that a highest frequency sub band of the bandwidth adjusted plurality of frequency sub bands extends beyond the bandwidth value associated with the one or more audio signals, reduce the highest frequency sub band of the bandwidth adjusted plurality of frequency sub bands to lie on or below the bandwidth value; merge a spatial audio parameter set associated with the first of the at least two consecutive frequency sub bands with a spatial audio parameter set associated with the second of the at least consecutive two frequency sub bands to give a merged spatial audio parameter set for the broadened frequency sub band; remove a spatial audio parameter set corresponding to each removed frequency sub band; and on the condition that the highest frequency sub band of the bandwidth adjusted plurality of frequency sub bands extends beyond the bandwidth value remove spatial audio parameter sets associated with the bandwidth adjusted plurality of frequency sub bands which extend beyond the bandwidth value.

The highest frequency sub band of the bandwidth adjusted plurality of frequency sub bands may comprise an upper sub band border value and a lower sub band border value encompassing a plurality of the plurality of frequency sub bands of the one or more audio signals, and the means configured to reduce the highest frequency sub band of the bandwidth adjusted plurality of frequency sub bands to lie on or below the bandwidth value may comprises means configured to: adjust the upper sub band border value to lie within the bandwidth value; and wherein the means configured to remove spatial audio parameter sets associated with the bandwidth adjusted plurality of frequency sub bands which extend beyond the bandwidth value comprises means configured to remove spatial audio parameter sets associated with the plurality of the plurality of frequency sub bands of the one or more audio signals which are above the adjusted upper sub band border value.

The means configured to map at least two consecutive sub bands of the plurality of frequency sub bands to a broadened frequency sub band to give the coding rate adjusted plurality of frequency sub bands based on the coding rate, may comprise means configured to: map a higher frequency band border value and a lower frequency band border value for the at least two consecutive frequency sub bands of the plurality of frequency sub bands to a lower frequency band border value and a higher frequency band border value of the broadened frequency sub band.

The lower frequency sub band border value and the higher frequency sub band border value of the broadened frequency sub band may be given by a lower frequency band border value and a higher frequency band border value of a frequency sub band reduction array comprising a plurality of frequency sub band borders in increasing order of frequency sub bands, wherein a sub band border value and a next higher sub band border value in increasing order of the frequency sub band reduction array are the lower frequency sub band border and the higher frequency sub band border respectively of the broadened frequency sub band.

The plurality of frequency sub band borders in the frequency sub band reduction array may constitute fewer frequency sub bands than the plurality of frequency sub bands of the one or more audio signals, and the coding rate adjusted plurality of frequency sub bands may be given by the frequency sub band reduction array, the frequency sub band reduction array may be selected from a plurality of frequency sub band reduction arrays, the selection may be based on the coding rate associated with the one or more audio signals, and each of the plurality of frequency sub band reduction arrays may comprise a different number of frequency sub bands, and each of the plurality of frequency sub band reduction arrays may be associated with a different coding rate associated with the one or more audio signals.

The number of frequency sub bands to be removed may be selected from a plurality of number of frequency sub bands to be removed, the selection may be based on the bandwidth value, and each of the plurality of number of frequency sub bands to be removed may be associated with a different bandwidth value.

The sampling frequency adjusted plurality of frequency sub bands may be in the form of an array comprising a plurality of frequency sub band border values in increasing order of frequency sub bands.

The apparatus may comprise a first encoder and second encoder for encoding the one or more audio signals at the coding rate, the coding rate may comprise the sum of an encoding rate for the first encoder and an encoding rate for the second encoder, the first encoder may encode an audio transport signal associated with the one or more audio signals, and the second encoder may encode the plurality of spatial audio parameter sets associated with the frequency sub bands of the one or more audio signals.

According to a second aspect there is an apparatus for spatial audio encoding one or more audio signals, wherein the apparatus comprises means configured to: determine a spatial audio parameter set for each of a plurality of frequency sub bands of the one or more audio signals; receive a coding rate associated with the one or more audio signals; map at least two consecutive sub bands of the plurality 10 of frequency sub bands to a broadened frequency sub band to give a coding rate adjusted plurality of frequency sub bands based on the coding rate; merge a spatial audio parameter set associated with the first of the at least two consecutive frequency sub bands with a spatial audio parameter set associated with the second of the at least consecutive two frequency sub bands to give a merged spatial audio parameter set for the broadened frequency sub band; determine an energy level for each frequency bin of the one or more audio signals; determine a cut off frequency sub band for the one or more audio signals by determining a highest frequency bin which has an energy level greater than a predetermined energy level and assigning the cut off frequency sub band as a frequency sub band which incorporates the highest frequency bin; compare the cut off frequency sub band for the one or more audio signals to a bandwidth value for the one or more audio signals; on condition of the cut off frequency sub band being less than the bandwidth value for the one or more audio signals remove, starting from the highest frequency sub band of the coding rate adjusted plurality of frequency sub bands, a number of frequency sub bands to give a bandwidth adjusted plurality of frequency sub bands, wherein the number of frequency sub bands removed is based on the cut off frequency sub band and remove a spatial audio parameter set corresponding to each removed frequency sub band; on condition that a highest frequency sub band of the bandwidth adjusted plurality of frequency sub bands extends beyond the cut off frequency sub band, reduce the highest frequency sub band of the bandwidth adjusted plurality of frequency sub bands to lie on or below the cut off frequency sub band value and remove spatial audio parameter sets associated with the bandwidth adjusted plurality of frequency sub bands which extend beyond the cut off frequency sub band; and encode the index of the cut off frequency sub band.

The means configured to encode the index of the cut off frequency sub band may be further configured to encode each spatial audio parameter set associated with the frequency sub bands below the cut off frequency sub band.

The means configured to encode each spatial audio parameter set associated with the frequency sub bands below the cut off frequency sub band may further comprise means configured to: determine an energy ratio parameter for each of the plurality of frequency sub bands of the one or more audio signals; quantize the energy ratio for each frequency sub band of the plurality of frequency sub bands which is greater than or equal to the cut off frequency band to a smallest quantization level; quantize the energy ratio for each frequency sub band of the plurality of frequency sub bands which is less than the cut off frequency band; and encode an indication that the number of spatial audio parameter sets encoded is less than the number of frequency sub bands of the one or more audio signals; and encode the number of spatial audio parameter sets which are not encoded using a Golomb Rice code.

The highest frequency sub band of the bandwidth adjusted plurality of frequency sub bands may comprise an upper sub band border value and a lower sub band border value encompassing a plurality of the plurality of frequency sub bands of the one or more audio signals, and the means configured to reduce the highest frequency sub band of the bandwidth adjusted plurality of frequency sub bands to lie on or below the cut off frequency sub band value and remove spatial audio parameter sets associated with the bandwidth adjusted plurality of frequency sub bands which extend beyond the cut off frequency sub band may comprise means configure to: adjust the upper sub band border value to lie within the cut off frequency sub band value; and remove spatial audio parameter sets associated with the plurality of the plurality of frequency sub bands of the one or more audio signals which are above the adjusted upper sub band border value.

The apparatus comprising means configured to map at least two consecutive sub bands of the plurality of frequency sub bands to a broadened frequency sub band to give the coding rate adjusted plurality of frequency sub bands based on the coding rate, may comprise means configured to: map a higher frequency band border value and a lower frequency band border value for the at least two consecutive frequency sub bands of the plurality of frequency sub bands to a lower frequency band border value and a higher frequency band border value of the broadened frequency sub band.

The lower frequency sub band border value and the higher frequency sub band border value of the broadened frequency sub band is given by a lower frequency band border value and a higher frequency band border value of a frequency sub band reduction array comprising a plurality of frequency sub band borders in increasing order of frequency sub bands, wherein a sub band border value and a next higher sub band border value in increasing order of the frequency sub band reduction array are the lower frequency sub band border and the higher frequency sub band border respectively of the broadened frequency sub band.

The plurality of frequency sub band borders in the frequency sub band reduction array may constitute fewer frequency sub bands than the plurality of frequency sub bands of the one or more audio signals, and the coding rate adjusted plurality of frequency sub bands may be given by the frequency sub band reduction array, the frequency sub band reduction array may be selected from a plurality of frequency sub band reduction arrays, wherein the selection may be based on the coding rate associated with the one or more audio signals, and wherein each of the plurality of frequency sub band reduction arrays may comprise a different number of frequency sub bands, and each of the plurality of frequency sub band reduction arrays may be associated with a different coding rate associated with the one or more audio signals.

The sampling frequency adjusted plurality of frequency sub bands may be in the form of an array comprising a plurality of frequency sub band border values in increasing order of frequency sub bands.

The apparatus may comprise a first encoder and second encoder for encoding the one or more audio signals at the coding rate, the coding rate may comprise the sum of an encoding rate for the first encoder and an encoding rate for the second encoder, the first encoder may encode an audio transport signal associated with the one or more audio signals, and the second encoder may encode the plurality of spatial audio parameter sets associated with the frequency sub bands of the one or more audio signals.

According to a third aspect there is a method for spatial audio encoding one or more audio signals, wherein the method comprises: determining a spatial audio parameter set for each of a plurality of frequency sub bands of the one or more audio signals; receiving a coding rate associated with the one or more audio signals; mapping at least two consecutive sub bands of the plurality of frequency sub bands to a broadened frequency sub band to give a coding rate adjusted plurality of frequency sub bands based on the coding rate; receiving a bandwidth value associated with the one or more audio signals; removing, starting from the highest frequency sub band of the coding rate adjusted plurality of frequency sub bands, a number of frequency sub bands to give a bandwidth adjusted plurality of frequency sub bands, wherein the number of frequency sub bands removed is based on the bandwidth value associated with the one or more audio signals; on condition that a highest frequency sub band of the bandwidth adjusted plurality of frequency sub bands extends beyond the bandwidth value associated with the one or more audio signals, reducing the highest frequency sub band of the bandwidth adjusted plurality of frequency sub bands to lie on or below the bandwidth value; merging a spatial audio parameter set associated with the first of the at least two consecutive frequency sub bands with a spatial audio parameter set associated with the second of the at least consecutive two frequency sub bands to give a merged spatial audio parameter set for the broadened frequency sub band; removing a spatial audio parameter set corresponding to each removed frequency sub band; and on the condition that the highest frequency sub band of the bandwidth adjusted plurality of frequency sub bands extends beyond the bandwidth value removing spatial audio parameter sets associated with the bandwidth adjusted plurality of frequency sub bands which extend beyond the bandwidth value.

According to a fourth aspect there is a method for spatial audio encoding one or more audio signals, wherein the method comprises: determining a spatial audio parameter set for each of a plurality of frequency sub bands of the one or more audio signals; receiving a coding rate associated with the one or more audio signals; map at least two consecutive sub bands of the plurality of frequency sub bands to a broadened frequency sub band to give a coding rate adjusted plurality of frequency sub bands based on the coding rate; merging a spatial audio parameter set associated with the first of the at least two consecutive frequency sub bands with a spatial audio parameter set associated with the second of the at least consecutive two frequency sub bands to give a merged spatial audio parameter set for the broadened frequency sub band; determining an energy level for each frequency bin of the one or more audio signals; determining a cut off frequency sub band for the one or more audio signals by determining a highest frequency bin which has an energy level greater than a predetermined energy level and assigning the cut off frequency sub band as a frequency sub band which incorporates the highest frequency bin; comparing the cut off frequency sub band for the one or more audio signals to a bandwidth value for the one or more audio signals; on condition of the cut off frequency sub band being less than the bandwidth value for the one or more audio signals removing, starting from the highest frequency sub band of the coding rate adjusted plurality of frequency sub bands, a number of frequency sub bands to give a bandwidth adjusted plurality of frequency sub bands, wherein the number of frequency sub bands removed is based on the cut off frequency sub band and remove a spatial audio parameter set corresponding to each removed frequency sub band; on condition that a highest frequency sub band of the bandwidth adjusted plurality of frequency sub bands extends beyond the cut off frequency sub band, reducing the highest frequency sub band of the bandwidth adjusted plurality of frequency sub bands to lie on or below the cut off frequency sub band value and removing spatial audio parameter sets associated with the bandwidth adjusted plurality of frequency sub bands which extend beyond the cut off frequency sub band; and encoding the index of the cut off frequency sub band.

According to a fifth aspect there is an apparatus for spatial audio encoding comprising at least one processor and at least one memory including computer program code, the at least one memory and the computer program code configured to, with the at least one processor, cause the apparatus to at least to: determine a spatial audio parameter set for each of a plurality of frequency sub bands of the one or more audio signals; receive a coding rate associated with the one or more audio signals; map at least two consecutive sub bands of the plurality of frequency sub bands to a broadened frequency sub band to give a coding rate adjusted plurality of frequency sub bands based on the coding rate; receive a bandwidth value associated with the one or more audio signals; remove, starting from the highest frequency sub band of the coding rate adjusted plurality of frequency sub bands, a number of frequency sub bands to give a bandwidth adjusted plurality of frequency sub bands, wherein the number of frequency sub bands removed is based on the bandwidth value associated with the one or more audio signals; on condition that a highest frequency sub band of the bandwidth adjusted plurality of frequency sub bands extends beyond the bandwidth value associated with the one or more audio signals, reduce the highest frequency sub band of the bandwidth adjusted plurality of frequency sub bands to lie on or below the bandwidth value; merge a spatial audio parameter set associated with the first of the at least two consecutive frequency sub bands with a spatial audio parameter set associated with the second of the at least consecutive two frequency sub bands to give a merged spatial audio parameter set for the broadened frequency sub band; remove a spatial audio parameter set corresponding to each removed frequency sub band; and on the condition that the highest frequency sub band of the bandwidth adjusted plurality of frequency sub bands extends beyond the bandwidth value remove spatial audio parameter sets associated with the bandwidth adjusted plurality of frequency sub bands which extend beyond the bandwidth value.

According to a six aspect there is an apparatus for spatial audio encoding comprising at least one processor and at least one memory including computer program code, the at least one memory and the computer program code configured to, with the at least one processor, cause the apparatus to at least to: determine a spatial audio parameter set for each of a plurality of frequency sub bands of the one or more audio signals; receive a coding rate associated with the one or more audio signals; map at least two consecutive sub bands of the plurality of frequency sub bands to a broadened frequency sub band to give a coding rate adjusted plurality of frequency sub bands based on the coding rate; merge a spatial audio parameter set associated with the first of the at least two consecutive frequency sub bands with a spatial audio parameter set associated with the second of the at least consecutive two frequency sub bands to give a merged spatial audio parameter set for the broadened frequency sub band; determine an energy level for each frequency bin of the one or more audio signals; determine a cut off frequency sub band for the one or more audio signals by determining a highest frequency bin which has an energy level greater than a predetermined energy level and assigning the cut off frequency sub band as a frequency sub band which incorporates the highest frequency bin; compare the cut off frequency sub band for the one or more audio signals to a bandwidth value for the one or more audio signals; on condition of the cut off frequency sub band being less than the bandwidth value for the one or more audio signals remove, starting from the highest frequency sub band of the coding rate adjusted plurality of frequency sub bands, a number of frequency sub bands to give a bandwidth adjusted plurality of frequency sub bands, wherein the number of frequency sub bands removed is based on the cut off frequency sub band and remove a spatial audio parameter set corresponding to each removed frequency sub band; on condition that a highest frequency sub band of the bandwidth adjusted plurality of frequency sub bands extends beyond the cut off frequency sub band, reduce the highest frequency sub band of the bandwidth adjusted plurality of frequency sub bands to lie on or below the cut off frequency sub band value and remove spatial audio parameter sets associated with the bandwidth adjusted plurality of frequency sub bands which extend beyond the cut off frequency sub band; and encode the index of the cut off frequency sub band.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows schematically an analysis processor according to some embodiments;

FIG. 3 shows schematically a spatial analyser according to some embodiments;

FIG. 4 shows a frequency band adjuster according to some embodiment;

FIG. 5 shows a flow diagram of an operation of the frequency band adjuster as shown in FIG. 4 according to some embodiments;

FIG. 6 shows a frequency band adjuster according to a further embodiment;

FIG. 7 shows a flow diagram of an operation of the frequency band adjuster according to the further embodiment shown in FIG. 6;

FIG. 8 shows a flow diagram of an operation of the frequency band adjuster incorporating the embodiments of FIG. 5 and FIG. 7; and

FIG. 9 shows schematically an example device suitable for implementing the apparatus shown.

### EMBODIMENTS OF THE APPLICATION

The following describes in further detail suitable apparatus and possible mechanisms for the provision of effective spatial analysis derived metadata parameters (MASA parameters.)

As discussed above Metadata-Assisted Spatial Audio (MASA) is an example of a parametric spatial audio format and representation suitable as an input format for IVAS.

It can be considered an audio representation consisting of ‘N channels+spatial metadata’. It is a scene-based audio format particularly suited for spatial audio capture on practical devices, such as smartphones. The idea is to describe the sound scene in terms of time- and frequency-varying sound source directions and, e.g., energy ratios. Sound energy that is not defined (described) by the directions, is described as diffuse (coming from all directions).

As discussed above spatial metadata associated with the audio signals may comprise multiple parameters (such as multiple directions and associated with each direction a direct-to-total ratio, spread coherence, distance, etc.) per time-frequency tile. The spatial metadata may also comprise other parameters or may be associated with other parameters which are considered to be non-directional (such as surround coherence, diffuse-to-total energy ratio, remainder-to-total energy ratio) but when combined with the directional parameters are able to be used to define the characteristics of the audio scene. For example, a reasonable design choice which is able to produce a good quality output is one where the spatial metadata comprises one or more directions for each time-frequency subframe (and associated with each direction direct-to-total energy ratios, spread coherence, distance values etc) are determined.

As described above, parametric spatial metadata representation can use multiple concurrent spatial directions. With MASA, the proposed maximum number of concurrent directions is two. For each concurrent direction, there may be associated parameters such as: Direction index; Direct-to-total energy ratio; Spread coherence; and Distance. In some embodiments, other parameters such as Diffuse-to-total energy ratio; Surround coherence; and Remainder-to-total energy ratio are defined.

In the following discussions multi-channel system is discussed with respect to a multi-channel microphone implementation. However as discussed above the input format may be any suitable input format, such as multi-channel loudspeaker, ambisonic (FOA/HOA), etc. Furthermore, the output of the example system is a multi-channel loudspeaker arrangement. However, it is understood that the output may be rendered to the user via means other than loudspeakers such as a binaural channel output. Furthermore, the multi-channel loudspeaker signals may be generalised to be two or more playback audio signals.

In addition, the IVAS codec as an extension to EVS may be used in store and forward applications in which the audio and speech content is encoded and stored in a file for playback.

The MASA metadata may consist of at least of spherical directions (elevation, azimuth), at least one direct-to-total energy ratio of a resulting direction, a spread coherence, and surround coherence independent of the direction, for each considered time-frequency (TF) block or tile, otherwise known as a time/frequency sub band. In total MASA may have a number of different types of metadata parameters for each time-frequency (TF) tile. The types of spatial audio parameters which can make up the metadata for MASA are shown in Table 1 below.

This data may be encoded and transmitted (or stored) by the encoder in order to be able to reconstruct the spatial signal at the decoder.

Moreover, in some instances metadata assisted spatial audio (MASA) may support up to 2 directions for each TF tile which would require the above parameters to be encoded and transmitted for each direction on a per TF tile basis. Thereby potentially doubling the required bit rate according to Table 1 below.

| Field | Bits | Description |
|---|---|---|
| Direction | 16 | Direction of arrival of the sound at a time-frequency |
| index | | parameter interval. Spherical representation at about 1- |
| | | degree accuracy. |
| | | Range of values: “covers all directions at about 1° accuracy” |
| Direct-to-total | 8 | Energy ratio for the direction index (i.e., time-frequency |
| energy ratio | | subframe). |
| | | Calculated as energy in direction / total energy. |
| | | Range of values: [0.0, 1.0] |
| Spread | 8 | Spread of energy for the direction index (i.e., time-frequency |
| coherence | | subframe). |
| | | Defines the direction to be reproduced as a point source or |
| | | coherently around the direction. |
| | | Range of values: [0.0, 1.0] |
| Diffuse-to- | 8 | Energy ratio of non-directional sound over surrounding |
| total energy | | directions. |
| ratio | | Calculated as energy of non-directional sound / total energy. |
| | | Range of values: [0.0, 1.0] |
| | | (Parameter is independent of number of directions |
| | | provided.) |
| Surround | 8 | Coherence of the non-directional sound over the surrounding |
| coherence | | directions. |
| | | Range of values: [0.0, 1.0] |
| | | (Parameter is independent of number of directions |
| | | provided.) |
| Remainder-to- | 8 | Energy ratio of the remainder (such as microphone noise) |
| total energy | | sound energy to fulfil requirement that sum of energy ratios |
| ratio | | is 1. |
| | | Calculated as energy of remainder sound / total energy. |
| | | Range of values: [0.0, 1.0] |
| | | (Parameter is independent of number of directions |
| | | provided.) |

The bitrate allocated for metadata in a practical immersive audio communications codec may vary greatly. Typical overall operating bitrates of the codec may leave only 2 to 10 kbps for the transmission/storage of spatial metadata. However, some further implementations may allow up to 60 kbps or higher for the transmission/storage of spatial metadata. The encoding of the direction parameters and energy ratio components has been examined before along with the encoding of the coherence data. However, whatever the transmission/storage bit rate assigned for spatial metadata there will always be a need to use as few bits as possible to represent these parameters especially when a TF tile may support multiple directions corresponding to different sound sources in the spatial audio scene.

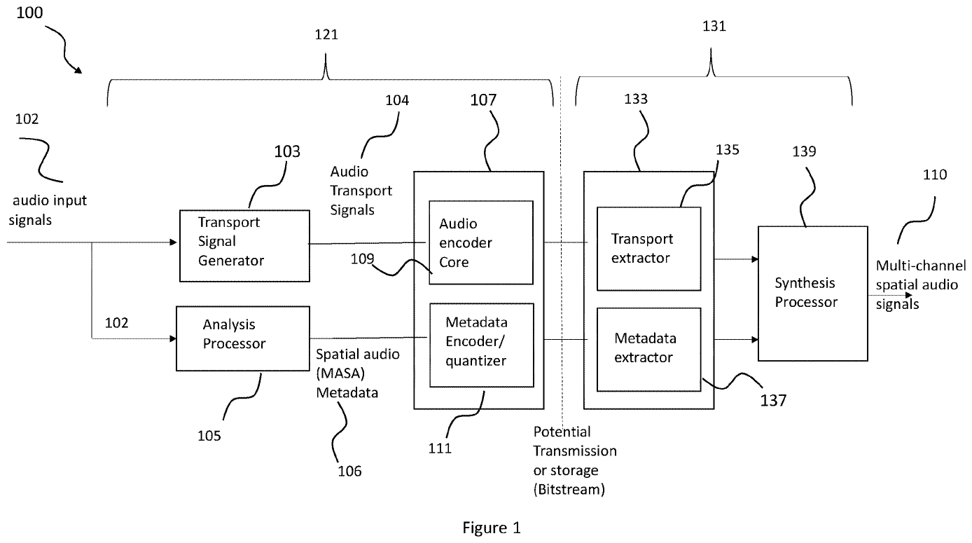

FIG. 1 depicts an example apparatus and system for implementing embodiments of the application. The system 100 is shown with an ‘analysis’ part 121 and a ‘synthesis’ part 131. The ‘analysis’ part 121 is the part from receiving the multi-channel signals up to an encoding of the metadata and transport signals and the ‘synthesis’ part 131 is the part from a decoding of the encoded metadata and transport signals to the presentation of the re-generated signal (for example in multi-channel loudspeaker form).

The input to the system 100 and the ‘analysis’ part 121 is the input audio signal 102.

In the following example the audio input signals 102 can be from a microphone array, however it would be appreciated that the audio input can be any suitable audio input format and the description hereafter details, where differences in the processing occurs when a differing input format is employed.

The audio input signals 102 can be from any suitable source, for example: two or more microphones mounted on a mobile phone, other microphone arrays, e.g., B-format microphone or Eigenmike. In some embodiments, as mentioned above, the input can be any suitable audio signal input such as Ambisonic signals, e.g., first-order Ambisonics (FOA), higher-order Ambisonics (HOA) or Loudspeaker surround mix and/or objects or any combination of the above.

In embodiments the microphone array audio input signals 102 may be provided to an analysis processor 105 configured to generate or determine suitable (spatial) metadata associated with the audio input signals 102. Additionally, the (microphone array) audio input signals 102 may also be provided to a suitable transport signal generator 103 to generate audio transport signals 104.

The analysis processor 105 is thus configured to perform spatial analysis on the audio input signals 102 yielding suitable spatial audio (MASA) metadata 106 in frequency bands. For all of the aforementioned input types, there exists known methods to generate suitable spatial metadata, for example directions and direct-to-total energy ratios (or similar parameters such as diffuseness, i.e., ambient-to-total ratios) in frequency bands. These methods are not detailed herein, however, some examples may comprise the performing of a suitable time-frequency transform for the input signals, and then in frequency bands when the input is a mobile phone microphone array, estimating delay-values between microphone pairs that maximize the inter-microphone correlation, and formulating the corresponding direction value to that delay and formulating a ratio parameter based on the correlation value.

In some embodiments when the audio input is a FOA signal or B-format microphone the analysis processor 105 can be configured to determine parameters such as an intensity vector, based on which the direction parameter is obtained, and to compare the intensity vector length to the overall sound field energy estimate to determine the ratio parameter. This method is known in the literature as Directional Audio Coding (DirAC).

In some embodiments when the audio input signal 102 is HOA signal, the analysis processor 105 may either take the FOA subset of the signals and use the method above, or divide the HOA signal into multiple sectors, in each of which the method above is utilized. This sector-based method is known in the literature as higher order DirAC (HO-DirAC). In this case, there is more than one simultaneous direction parameter per frequency band.

In some embodiments when the audio input signal 102 is a loudspeaker surround mix and/or objects, the analysis processor 105 may be configured to convert the signal into a FOA signal(s) (via use of spherical harmonic encoding gains) and to analyse direction and ratio parameters as above.

As such the output of the analysis processor 105 is spatial audio (MASA) metadata 106 determined in frequency bands. The spatial audio (MASA) metadata 106 may involve directions and energy ratios in frequency bands but may also have any of the metadata types listed previously. The spatial audio (MASA) metadata 106 can vary over time and over frequency.

In some embodiments the analysis processor functionality is implemented external to the system 100. For example, in some embodiments the spatial audio (MASA) metadata 106 associated with the audio input signals 102 may be provided to an encoder 107 as a separate bit-stream. In some embodiments the spatial audio (MASA) metadata 106 may be provided as a set of spatial (direction) index values.

The system 100 described above is further configured to implement transport signal generator 103, to generate suitable audio transport signals 104. The transport signal generator 103 is configured to receive the audio input signals 102, which may for example be the microphone array audio signals and generate the audio transport signals 104. The audio transport signals 104 may be a multi-channel, stereo, binaural or mono audio signal. The generation of audio transport signals 104 can be implemented using any suitable method such as summarised below.

When the audio input signals 102 are microphone array audio signals, the transport signal generator 103 functionality may select a left-right microphone pair, and apply suitable processing to the signal pair, such as automatic gain control, microphone noise removal, wind noise removal, and equalization.

When the input is a FOA/HOA signal or B-format microphone, the audio transport signals 104 may be directional beam signals towards left and right directions, such as two opposing cardioid signals.

When the input is loudspeaker surround mix and/or objects, the audio transport signals 104 may be a downmix signal that combines left side channels to left downmix channel, and same for right side, and adds centre channels to both transport channels with a suitable gain.

In some embodiments the audio transport signals 104 are the audio input signals 102, for example the microphone array audio signals. For example, in some situations, where the analysis and synthesis occur at the same device at a single processing step, without intermediate encoding. The number of audio transport channels can also be any suitable number (rather than one or two channels as discussed in the examples).

The transport signal generator 103 and analysis processor 105 can in some embodiments be a computer (running suitable software stored on memory and on at least one processor), or alternatively a specific device utilizing, for example, FPGAs or ASICs.

The transport signals 104 and the spatial audio (MASA) metadata 106 may be passed to an encoder 107.

The encoder 107 may comprise an audio encoder core 109 which is configured to receive the audio transport (for example downmix) signals 104 and generate a suitable encoding of these audio signals. The encoder 107 can in some embodiments be a computer (running suitable software stored on memory and on at least one processor), or alternatively a specific device utilizing, for example, FPGAs or ASICs. The encoding may be implemented using any suitable scheme. The encoder 107 may furthermore comprise a metadata encoder/quantizer 111 which is configured to receive the spatial audio (MASA) metadata 106 and output an encoded or compressed form of the information. In some embodiments the encoder 107 may further interleave, multiplex to a single data stream or embed the metadata within encoded downmix signals before transmission or storage shown in FIG. 1 by the dashed line. The multiplexing may be implemented using any suitable scheme.

In the decoder side, the received or retrieved data (stream) may be received by a decoder/demultiplexer 133. The decoder/demultiplexer 133 may demultiplex the encoded streams and pass the audio encoded stream to a transport extractor 135 which is configured to decode the audio signals to obtain the transport signals. Similarly, the decoder/demultiplexer 133 may comprise a metadata extractor 137 which is configured to receive the encoded metadata and decode metadata. The decoder/demultiplexer 133 can in some embodiments be a computer (running suitable software stored on memory and on at least one processor), or alternatively a specific device utilizing, for example, FPGAs or ASICs.

The decoded metadata and transport audio signals may be passed to a synthesis processor 139.

The system 100 ‘synthesis’ part 131 further shows a synthesis processor 139 configured to receive the encoded audio transport signals and the encoded spatial audio (MASA) metadata and re-create in any suitable format a synthesized spatial audio in the form of multi-channel spatial audio signals 110 (these may be multichannel loudspeaker format or in some embodiments any suitable output format such as binaural or Ambisonics signals, depending on the use case) based on the encoded audio transport signals and the encoded spatial audio (MASA) metadata.

Therefore, in summary first the system (analysis part) is configured to receive multi-channel audio signals.

Then the system (analysis part) is configured to generate a suitable transport audio signal (for example by selecting or downmixing some of the audio signal channels) and the spatial audio parameters as metadata.

The system is then configured to encode for storage/transmission the audio transport signal and the spatial audio (MASA) metadata.

After this the system may store/transmit the encoded audio transport signal and encoded spatial audio (MASA) metadata.

The system may retrieve/receive the encoded audio transport signal and encoded spatial audio (MASA) metadata.

Then the system is configured to extract the audio transport signal and spatial audio (MASA) metadata from encoded audio transport signal and encoded spatial audio (MASA) metadata parameters, for example by demultiplexing and decoding the encoded audio transport signal and encoded spatial audio (MASA) metadata parameters.

The system (synthesis part) is configured to synthesize an output multi-channel spatial audio signal based on extracted audio transport audio signals and spatial audio (MASA) metadata.

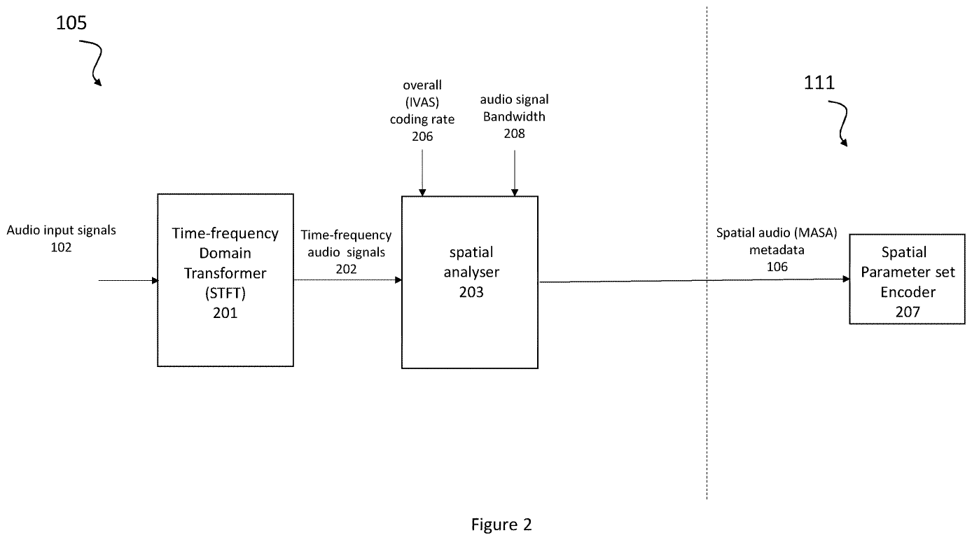

FIG. 2 is an example analysis processor 105 and Metadata encoder/quantizer 111 (as shown in FIG. 1) according to some embodiments is described in further detail.

FIGS. 1 and 2 depict the Metadata encoder/quantizer 111 and the analysis processor 105 as being coupled together. However, it is to be appreciated that some embodiments may not so tightly couple these two respective processing entities such that the analysis processor 105 can exist on a different device from the Metadata encoder/quantizer 111. Consequently, a device comprising the Metadata encoder/quantizer 111 may be presented with the audio transport signals 104 and metadata streams for processing and encoding independently from the process of capturing and analysing.

The analysis processor 105 in some embodiments comprises a time-frequency domain transformer 201.

In some embodiments the time-frequency domain transformer 201 is configured to receive the audio input signals 102 and apply a suitable time to frequency domain transform such as a Short Time Fourier Transform (STFT) in order to convert the audio input time domain signals into suitable time-frequency audio signals 202. These time-frequency audio signals 202 may be passed to a spatial analyser 203.

Thus, for example, the time-frequency audio signals 202 may be represented in the time-frequency domain representation by

sᵢ(b,n),

where b is the frequency bin index and n is the time-frequency block (frame) index and i is the channel index. In another expression, n can be considered as a time index with a lower sampling rate than that of the original time-domain signals. These frequency bins can be grouped into sub bands that group one or more of the bins into a sub band of a band index k=0, . . . , K−1. Each sub band k has a lowest bin b_{k,low} and a highest bin b_{k,high}, and the subband contains all bins from b_{k,low} to b_{k,high}. The widths of the sub bands can approximate any suitable distribution. For example, the Equivalent rectangular bandwidth (ERB) scale or the Bark scale.

A time frequency (TF) tile (or block) is thus a specific sub band within a subframe of the frame.

It can be appreciated that the number of bits required to represent the spatial audio parameters may be dependent at least in part on the TF (time-frequency) tile resolution (i.e., the number of TF subframes or tiles). For example, a 20 ms audio frame may be divided into 4 time-domain subframes of 5 ms a piece, and each time-domain subframe may have up to 24 frequency sub bands divided in the frequency domain according to a Bark scale, an approximation of it, or any other suitable division. In this particular example the audio frame may be divided into 96 TF subframes/tiles, in other words 4 time-domain subframes with 24 frequency sub bands. Therefore, the number of bits required to represent the spatial audio parameters for an audio frame can be dependent on the TF tile resolution. For example, if each TF tile were to be encoded according to the distribution of Table 1 above then each TF tile would require 64 bits (for one sound source direction per TF tile) and 104 bits (for two sound source directions per TF tile, taking into account parameters which are independent of the sound source direction).

In embodiments the analysis processor 105 may comprise a spatial analyser 203. The spatial analyser 203 may be configured to receive the time-frequency audio signals 202 and based on these signals estimate a set of spatial audio parameters for each TF tile. Which is collectively shown in FIG. 1 as the spatial audio (MASA) metadata 106. The spatial audio (MASA) metadata 106 may comprise direction parameters. The direction parameters may be determined based on any audio based ‘direction’ determination.

For example, in some embodiments the spatial analyser 203 is configured to estimate the direction of a sound source with two or more signal inputs.

The spatial analyser 203 may thus be configured to provide at least one azimuth and elevation (the spatial audio direction parameters) for each frequency band and temporal time-frequency block within a frame of an audio signal, denoted as azimuth φ(k,n), and elevation θ(k,n). The spatial audio direction parameters for the time sub frame may be passed to the spatial parameter set encoder 207.

The spatial analyser 203 may also be configured to determine energy ratio parameters. The energy ratio may be considered to be a determination of the energy of the audio signal which can be considered to arrive from a direction. For example, the direct-to-total energy ratio r(k,n) can be estimated using a stability measure of the directional estimate, or using any correlation measure, or any other suitable method to obtain a ratio parameter such as described in patent publication EP3542546. Each direct-to-total energy ratio corresponds to a specific spatial direction and describes how much of the energy comes from the specific spatial direction compared to the total energy. This value may also be represented for each time-frequency tile separately. The spatial direction parameters and direct-to-total energy ratio describe how much of the total energy for each time-frequency tile is coming from the specific direction. In general, a spatial direction parameter can also be thought of as the direction of arrival (DOA).

The direct-to-total energy ratio parameter for multichannel capture microphone array signals can be estimated based on the normalized cross-correlation parameter cor′(k,n) between a microphone pair at band k, the value of the cross-correlation parameter lies between −1 and 1. The direct-to-total energy ratio parameter r(k,n) can be determined by comparing the normalized cross-correlation parameter to a diffuse field normalized cross correlation parameter cor′_{D}(k,n) as

$$r ( k , n ) = \frac{{cor}^{′} ( k , n ) - {cor}_{D}^{′} ( k , n )}{1 - {cor}_{D}^{′} ( k , n )} .$$

The direct-to-total energy ratio is explained further in PCT publication WO2017/005978 which is incorporated herein by reference. The energy ratio may be passed to the spatial parameter set encoder 207.

The spatial analyser 203 may furthermore be configured to determine a number of coherence parameters 112 which may include surrounding coherence (γ(k,n)) and spread coherence (ζ(k,n)), both analysed in time-frequency domain.

The term audio source may relate to dominant directions of the propagating sound wave, which may encompass the actual direction of the sound source.

Therefore, for each sub band k there will be collection (or set) of spatial audio parameters associated with the sub band k and sub frame n. In this instance each sub band k and sub frame n (in other words a TF tile) may have the following spatial audio parameters associated with it on a per audio source direction basis; at least one azimuth and elevation denoted as azimuth φ(k,n), and elevation θ(k,n), and a spread coherence (ζ(k,n) and a direct-to-total-energy ratio parameter r(k,n). If there is more than one direction per TF tile, then the TF tile can have each of the above listed parameters associated with each sound source direction. Additionally, the collection of spatial audio parameters may also comprise a surrounding coherence (γ(k,n)). Parameters may also comprise a diffuse-to-total energy ratio r_{diff} (k,n).

In embodiments the diffuse-to-total energy ratio r_{diff}(k,n) is the energy ratio of non-directional sound over surrounding directions and there is typically a single diffuse-to-total energy ratio (as well as surrounding coherence (γ(k,n)) per TF tile. The diffuse-to-total energy ratio may be considered to be the energy ratio remaining once the direct-to-total energy ratios (for each direction) have been subtracted from one. Going forward, the above parameters may be termed a set of spatial audio parameters (or a spatial audio parameter set) for a particular TF tile. The collection of spatial audio parameter sets associated with the TF tiles are known as the spatial audio (MASA) metadata signal 106.

The spatial parameter data sets are then passed to the metadata encoder/quantizer 111 for encoding and quantization. In FIG. 2 this is depicted by the spatial parameter set encoder 207 which can be arranged to receive the spatial parameter data sets (depicted as the spatial audio MASA metadata stream 106) and to quantize and encode the spatial parameter sets associated which each TF tile.

The audio input signals 102 can be processed in the frequency domain to the same frequency sub band resolution by both the transport signal generator 103 and the analysis processor 105. However, some of the resulting frequency sub bands in the audio transport signals 104 (from the processing in the transport signal generator 103) may contain small (or even zero) levels of signal energy with the effect that signals associated with these sub bands have a negligible or at best a small contribution to the overall synthesized multi-channel (spatial) audio signal 110. This would indicate that an audio signal within “low energy” frequency sub bands can be ignored and not encoded (by the audio core encoder 109) for subsequent transmission and storage.

However, as the system stands now, the analysis processor 105 is generating spatial audio parameter sets for each sub band of a subframe of the processed audio input signal 102. Consequently, there can be a mismatch between the number of sub bands over which the audio transport signals 104 contain a so-called active audio signal and the number of sub bands over which the audio input signals 102 is analysed for the spatial audio (MASA) metadata signal 106. In other words, the analysis processor 105 can be producing spatial parameter data sets for each sub band of a sub frame of the audio input signals 102 irrespective of whether a corresponding frequency sub band of the audio transport stream/signals 104 contains an active audio signal.

Consequently, spatial audio parameter sets corresponding to frequency sub bands (on a per sub frame basis) of the audio transport signal/stream 10 with inactive audio signal can considered to be needlessly encoded. Therefore, encoding of these spatial audio parameters sets can in turn lead to a needless expenditure of bits.

Note, the term active audio signal, as applied above, refers to the situation of an audio signal of a sub band of a sub frame of the audio transport signal 104 having a high enough level of energy that the audio signal is considered to contribute to the synthesized multichannel spatial audio signals 110. Conversely the term inactive audio signal may refer to the situation of sub band of a sub frame of the audio transport signal 104 having a low audio signal energy level such that the sub band can be considered to not make a noticeable contribution to the synthesized multichannel spatial audio signals 110.

Embodiments therefore proceed from the consideration that the number of spatial audio parameter sets of the spatial audio (MASA) metadata stream 106 can be reduced if the energy in frequency sub bands of the audio transport signals 104 make a negligible contribution to the output multichannel spatial audio signals 110.

Additionally, as described previously the IVAS codec can operate at a range of different encoding rates and different bandwidths, and this can lead to a mismatch between the number of sub bands over which the audio input signal 102 is processed for the audio transport stream 104 and the number of sub bands over which the audio input signal 102 is analysed for the spatial (MASA) metadata stream 106. Part of the reason for the mismatch between the number of sub bands (over which audio transport stream 104 and the spatial (MASA) metadata stream 106 are processed) may at least be in part due to the encoding rate allocated for the encoding of the audio transport stream 104 and the separate encoding rate allocated for the spatial (MASA) metadata stream 106. For instance, the audio transport stream 104 and the spatial (MASA) metadata stream 106 may each be encoded according to anyone of a number of different encoding rates. The encoding rate allocated for each stream can in turn influence the number of sub bands over which the audio transport 104 and spatial (MASA) metadata 106 streams are produced. For instance, the coding rate allocated for the encoding of the audio transport stream 104 may result in fewer sub bands being generated than the number of sub bands over which the spatial audio parameters of the spatial (MASA) metadata stream 106 are generated.

Consequently, the frequency bands of the spatial (MASA) metadata stream 106 may extend beyond the frequency bands of the audio transport stream 104. This can result in the needless encoding of the spatial audio parameters associated with the sub bands of the spatial (MASA) metadata stream 106 which extend beyond the sub bands of the audio transport stream 104, which in turn results in a needless expenditure of encoding bits during the encoding of the spatial (MASA) metadata stream 106.

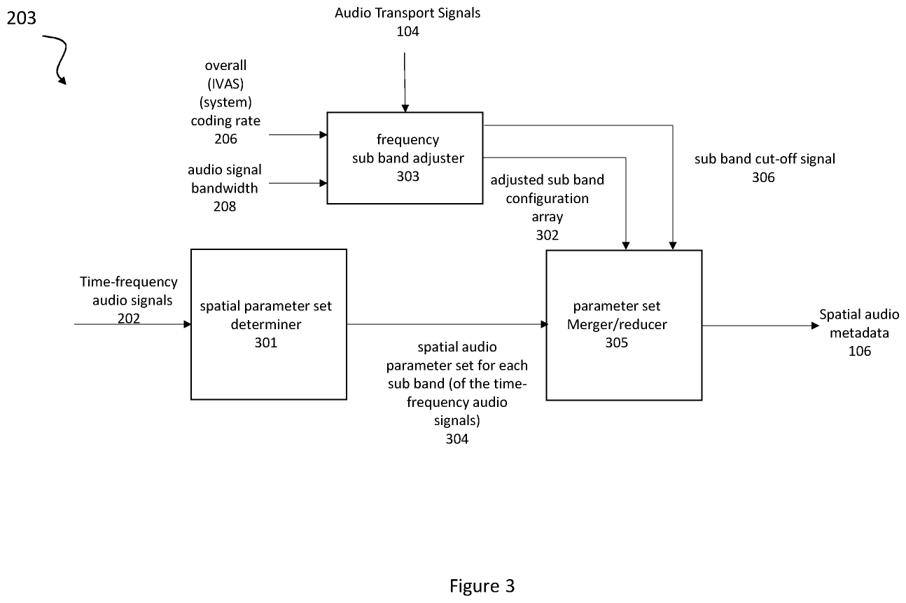

In this regard, FIG. 3 shows the spatial analyser 203 in further detail. Where the time-frequency audio signals 202 are received by the spatial parameter set determiner 301. The spatial parameter set determiner 301 may be arranged to determine a spatial parameter set for each sub band of the time-frequency audio signals 202. The constituents of each parameter set can be at least some of the spatial audio parameters as discussed above and listed in Table 1.

It is to be noted that in some other embodiments the spatial parameter set determiner 301 may be implemented in the spatial analyser 203 in the analysis processor 105 and the frequency sub band adjuster 303 and parameter set merger/reducer 305 may form part of the metadata encoder/quantizer 111, and that the analysis processor 105 can exist on a different device from the Metadata encoder/quantizer 111.

Also shown in FIG. 3 is the frequency sub band adjuster 303. The frequency sub band adjuster 303 may be configured to receive input configuration information, such as the (selected) overall (IVAS) coding rate 206 and the (selected) audio signal bandwidth 208. Additionally, the frequency sub band adjuster 303 may also be arranged to receive the audio transport signals 104.

The frequency sub band adjuster 303 may then produce a further arrangement of sub bands in response to the received input configuration information, the overall (IVAS) coding rate 206 and the audio signal bandwidth 208. This further arrangement of sub bands may be based on the original arrangement of sub bands of the time-frequency audio signals 202 however with some changes to the distribution and width of some of the frequency sub bands and hence a change to the number of sub bands across the bandwidth of the signal. For instance, the further arrangement of sub bands may comprise fewer and wider sub bands when compared to the pattern of the sub bands for the time-frequency audio signals 202.

In embodiments where the input to the frequency sub band adjuster 303 comprises the audio transport signal 104. The arrangement of frequency sub bands of the original time-frequency audio signal 102 may be reduced in response to the energy of each corresponding sub band of the audio transport signals 104. In other words, the arrangement of frequency sub bands as produced by the frequency sub band adjuster 303 may be made fewer by removing frequency sub bands from the original pattern of sub bands of the time-frequency audio signals 202. Thereby the resultant frequency sub band arrangement, in response to the energy levels of the frequency sub bands of the audio transport signals 104, may comprise fewer sub bands of the original width.

The output from the frequency sub band adjuster 303 is shown as the adjusted sub band configuration array 302 in FIG. 3. This parameter may reflect the changes to the boundaries of the (or removal of) frequency sub bands of the original time-frequency audio signal 202 in the form of an array of sub band boundary values. In other words, the adjusted sub band configuration array 302 may represent a pattern of sub band boundaries after the encoder operating conditions of selected coding rate (overall IVAS coding rate 206) and selected bandwidth (audio signal bandwidth 208) have been accounted for. Note, the overall (IVAS) coding rate 206 merely serves as an example of how the encoding rate may be parameterized. This do not preclude any other parameter which may indicate an encoding rate for the encoder. For example, the encoding rate parameter (such as the input 206) may be set according to a coding rate of the audio encoder 109, or to a coding rate associated with the metadata encoder and quantizer 111.

The adjusted sub band configuration parameter 302 may then be passed to the parameter set merger/reducer 305.

In addition to the adjusted sub band configuration parameter 302, the parameter set merger/reducer 305 also receives the spatial audio parameter set for each frequency sub band 304 of the time-frequency audio signal 202.

When the inputs to the spatial analyser 203 comprise the overall (IVAS) coding rate 206 and audio signal sampling frequency 208, the parameter set merger/reducer 305 may be arranged to perform a merging operation between some of the spatial parameter sets 304. The merging operation may be performed in accordance with the sub band configuration of the sub band configuration parameter/array 302. In essence, some of the spatial parameter sets (for the time-frequency audio signals 202) may be merged with neighbouring spatial parameter sets such that the resulting distribution of spatial parameter sets mirrors the distribution of sub bands as indicated by the adjusted sub band configuration parameter 302. A description of the merging process may be found in the patent application publication WO2021/130404. In which it is taught that spatial audio parameters sets over neighbouring sub bands may be merged to give fewer spatial audio parameter sets across a fewer number of merged frequency bands.

When the inputs to the spatial analyser 203 comprise the audio transport signals 104, the parameter set merger/reducer 305 may be arranged to reduce the number of spatial audio parameter sets from the signal 304 as indicated by the sub band cut off signal 306. In this case, the adjusted sub band cut off signal 306 may contain information indicating the spatial parameter sets which are to be removed from the spatial audio parameter sets signal 304.

The output from the parameter set merger/reducer 305 (i.e. the spatial audio metadata 106) may then either comprise the spatial audio parameter sets of the signal 304 which have been merged into a fewer number of spatial audio parameter sets, and/or the spatial audio parameter sets of the signal 304 which have been reduced into a fewer number of spatial audio parameter sets.

The following describes embodiments which generate the spatial audio metadata 106 in response to the adjusted sub band configuration array 302. That is the output from the parameter set merger/reducer 305 is the spatial audio metadata 106 comprising a fewer number of merged spatial audio parameter sets of the spatial audio parameter sets signal 304, in response to the audio signal bandwidth (parameter) 208 and the overall (IVAS/encoding system) coding rate 206.

To that end, the spatial audio (MASA) metadata 106 may be encoded (by the encoder 207) at various coding rates between 2.5 kbps to 65 kbps. The specific rate chosen may be tied to the overall (IVAS or system) encoding rate 206, which for IVAS may be one of the following;

$${/}^{*} IVAS\_ 13 k 2 , IVAS\_ 16 k 4 , IVAS\_ 24 k 4 , \\ IVAS\_ 32 k , IVAS\_ 48 k , IVAS\_ 64 k , IVAS\_ 80 k , IVAS\_ 96 k , IVAS\_ 128 k , \\ IVAS\_ 160 k , IVAS\_ 192 k , IVAS\_ 256 k , IVAS\_ 384 k , IVAS\_ 512 k {.}^{*} /$$

Where for example IVAS_13k2 signifies an IVAS encoding rate of 13.2 kbps. The overall (IVAS) coding rate 206 may be used by the frequency sub band adjuster 303 to determine in part the sub band boundaries for the adjusted sub band configuration parameter 302.

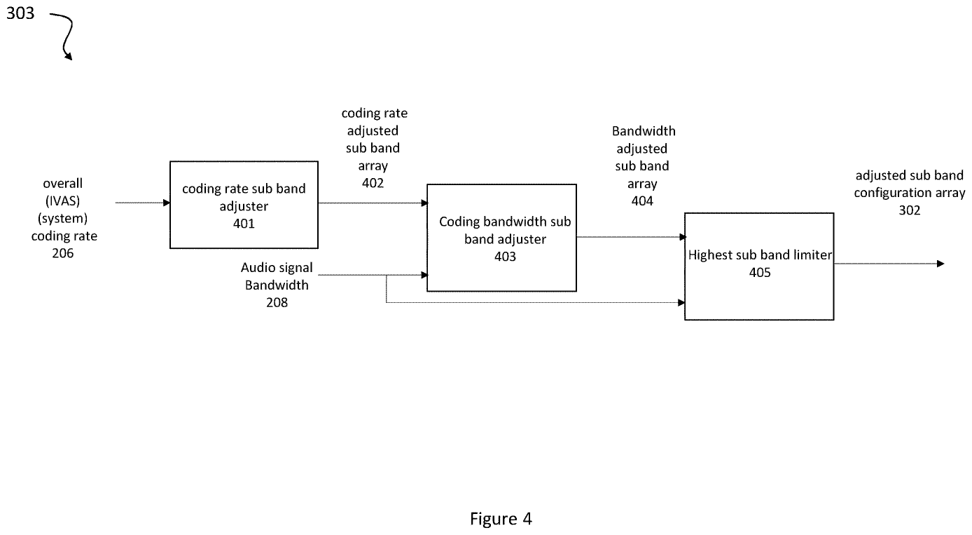

In this regard, FIG. 4 shows the frequency sub band adjuster 303 in further detail for the case when the adjusted sub band configuration array 302 is generated in response to the combination of inputs comprising the overall (IVAS) coding rate 206 and the audio signal bandwidth (parameter) 208.

The overall system coding rate (IVAS coding rate) 206 is shown as being received by the coding rate sub band adjuster 401. The output from the coding rate sub band adjuster 401 is shown as the coding rate adjusted sub band array 402.

In embodiments the coding rate sub band adjuster 401 may be arranged to perform a mapping function between an overall coding rate 206 and a particular distribution of frequency sub bands in relation to the distribution of sub bands in the time-frequency audio signals 202. In other words, the result of the mapping function is the coding rate adjusted sub band array 402.

The mapping may be performed so that the distribution of the coding rate adjusted sub bands is more closely aligned to the width and number of frequency sub bands of the transport audio signals 104. The time-frequency audio signals 202 may comprise 24 frequency sub bands across its bandwidth. The mapping functionality in 401 may then be arranged to take the overall (IVAS) coding rate 206 and map the coding rate to a distribution of frequency sub bands which is different to the distribution of frequency sub bands of the time-frequency audio signals 202. The coding rate adjusted sub band array 402 may have fewer number of sub bands, with some of the sub bands being wider than their counterpart sub bands in the time-frequency audio signals 202. Therefore, the resulting coding rate adjusted sub bands continue to extend across the equivalent bandwidth (of the 24 bands) of the original time-frequency audio signal 202 but with fewer sub bands.

In embodiments the mapping function may be implemented by initially mapping the received overall (IVAS) coding rate 206 to a parameter which indicates the number of sub bands in the coding rate adjusted sub band array. There may be a one-to-one mapping between each overall (IVAS) coding rate 206 and the parameter indicating the reduced number of sub bands. An example of the one-to-one mapping for IVAS is shown by Table 2 below

TABLE 2

| | IVAS rate kbps | | | | | | | | | | | | | |
|---|---|---|---|---|---|---|---|---|---|---|---|---|---|---|
| | 13.2 | 16.4 | 24.4 | 32 | 48 | 64 | 80 | 96 | 128 | 160 | 192 | 256 | 384 | 512 |
| MASA Nos | 5 | 5 | 5 | 5 | 5 | 5 | 5 | 5 | 8 | 12 | 18 | 24 | 24 | 24 |
| of sub bands | | | | | | | | | | | | | | |

For example, an overall IVAS encoding rate of 160 kbps would lead to a reduction in the number of sub bands from 24 to 12 in the coding rate adjusted sub band array 402.

It is to be noted each number of sub bands in the above Table 2, refers to a continuous run of sub bands starting from the lowest sub band, and the coding rate adjusted sub band array 402 extends across the whole bandwidth occupied by the 24 sub bands of the time-frequency audio signals 202.

Each parameter indicating the reduced number of sub bands of the above table maps to an IVAS coding rate in an increasing order of bitrate. Taking another example, the parameter indicating the reduced number of sub bands for the IVAS encoding rate of 32 kbps is 5 sub bands. In this example the coding rate adjusted sub band array will comprise elements marking the sub band boundaries of the 5 sub bands.

To be clear any reduction in the number of sub bands in relation to the time-frequency audio signals 202 which may be performed is made in light of the maximum number of sub bands, which in the above example is given as 24. Therefore, any adjustments made to the number of sub bands is performed on the basis that the full bandwidth of the signal is preserved. In essence, the width of some of the frequency sub bands are expanded to occupy a wider range of frequency bins whilst preserving the full bandwidth associated with the time-frequency audio signals 202 (which for IVAS is 24 sub bands or 60 frequency bins where each frequency bin has a width of 400 Hz.)

Once the parameter indicating the reduced number of sub bands has been found from the above Table 2 there may be change to the width of some of the remaining sub bands so that the full bandwidth of the signal is preserved as explained above. The redistribution of the number of frequency bins for some of the reduced number of sub bands, may be found by using the following mapping arrays.

The distribution of frequency bins for the 24 sub bands of the time-frequency audio signal 202 may be given by the following array MASA_band_grouping_24. In other words, this is the distribution of frequency bins for each sub band of 24 sub band grouping, where the maximum number of frequency bins is 60, with each bin having a width of 400 Hz.

$$int16 MASA\_band \_mapping \_ 24 [ 24 + 1 ] = \\ \{ 0 , 1 , 2 , 3 , 4 , 5 , 6 , 7 , 8 , 9 , 10 , 11 , 12 , \\ 13 , 14 , 15 , 16 , 17 , 18 , 19 , 20 , 25 , 30 , 40 , 60 \} ;$$

Each member of the MASA_band_grouping is an indication of the frequency bin index of the lower/upper border of a sub band. The frequency bin indices are grouped collectively in the above grouping array in an ascending order. For example, in the above MASA band grouping the 24^{th} sub band is assigned the range of frequency bins from 40 to 60, the 23^{rd} sub band is assigned the range frequency bins from 30 to 40 and the first sub band is assigned the frequency bins from 0 to 1. It is to be noted that the assignment of frequency bins to sub bands typically does not include the last value of the range of frequency bins, so in fact the frequency bins assigned to the 24^{th} sub band would be 40 to 59, and similarly the range of frequency bins assigned to the 23^{rd} sub band would be 30 to 39.

The redistribution of frequency sub bands for each value of the parameter indicating the reduced number of sub bands the reduction in Table 2 may be given by the following MASA_band_mapping arrays.

For example, the coding rate adjusted sub band array 402 for a reduction from 24 sb to 18 sb, as a result if the overall (IVAS) coding rate being 192 kbps, may be given by the array below

$$int16 MASA\_band \_mapping \_ 24 \_to \_ 18 [ 18 + 1 ] = 0 , \\ 1 , 2 , 3 , 4 , 5 , 6 , 7 , 8 , 9 , 10 , 12 , 14 , 17 , 20 , 21 , 22 , 23 , 24 \} ;$$

In this example, the 18^{th} sub band of the coding rate adjusted sub band array is assigned to the frequency bins covering the 23^{rd} to 24^{th} sub bands in relation to the original sub bands of the time-frequency audio signals 202, where the frequency bins allocated for each sub band is given by the above MASA_band_grouping array. In other words, the 18^{th} sub band occupies the range of frequency bins from 40 to 60. The 17^{th} sub band of the coding rate adjusted sub band array 402 is assigned the range of frequency bins covering the 22^{nd} and 23^{rd} sub band from the above MASA_band_grouping array, i.e. the range of frequency bins from 30 to 40, and so on.

Likewise, in the instance the reduced sub band count is 12 sb because of an IVAS coding rate of 160 kbps. The coding rate adjusted sub band array 402 is given by the array below.

$$int16 MASA\_band \_mapping \_ 24 \_to \_ 12 [ 12 + 1 ] = \\ \{ 0 , 1 , 2 , 3 , 4 , 5 , 7 , 9 , 12 , 15 , 20 , 22 , 24 \} ;$$

In a similar manner the coding rate adjusted sub band array 402 for a reduced sub band counts from 24 sb to 8 sb and 24 sb to 5 sb may be given by the following arrays respectively.

$$int16 MASA\_band \_mapping \_ 24 \_to \_ 8 [ 8 + 1 ] = \\ \{ 0 , 1 , 2 , 3 , 5 , 8 , 12 , 20 , 24 \} ;$$

$$int16 MASA\_band \_mapping \_ 24 \_to \_ 5 [ 5 + 1 ] = \\ \{ 0 , 1 , 3 , 7 , 15 , 24 \} ;$$

It is to be noted that the coding rate adjusted sub band array can be any of the arrays from MASA_band_mapping_24_to_18 to MASA_band_mapping_24_to_5. Consequently, the coding rate adjusted sub band array contains a “pattern” of sub bands (in terms of the sub bands of the MASA_band_grouping_24) in response to the overall (IVAS) system determined coding rate 206.

Returning to FIG. 4 it may be seen that the output, the coding adjusted sub band array 402, from the coding rate frequency sub band adjuster 401 may be passed to the coding bandwidth sub band adjuster 403. The coding bandwidth sub band adjuster 403 is configured to receive the audio signal bandwidth 208 which may be used to reduce the sampling frequency/bandwidth associated with the coding rate adjusted sub band array 402 with respect to the time-frequency audio signals 202. In embodiments this process typically requires removing higher sub bands of the coding rate adjusted sub band array 402, so that the full bandwidth of an audio signal associated with the coding rate adjusted sub band array 402 is reduced in line with the bandwidth indicated by the audio signal bandwidth input 208.

The output from the sampling frequency sub band adjuster can be referred to as the bandwidth adjusted sub band array 404.

The reduction in bandwidth of the coding rate adjusted sub band array 402 (due to audio signal bandwidth 208) may be performed using a table in which the reduction in the number of sub bands from the (full band) coding rate adjusted sub band array is given for each possible input audio signal bandwidth 208.

Note the encoder 121 is capable of operating at one of a number of different pre-specified bandwidths as indicated by the audio signal bandwidth signal line 208. For example, the IVAS encoder may be configured to operate at any one of the audio signal bandwidths specified in Table 3.

In this regard, the bandwidth adjustment Table 3 below depicts the relationship between the input audio signal bandwidth 208 and the coding rate adjusted sub band array 402. Along the columns of Table 3 lie various allowed audio signal sampling frequencies/bandwidth and along the rows of the mapping Table 3 lie the coding rate adjusted sub band array. Table 3 provides, for each value of audio signal bandwidth 208 the number of sub bands which are required to be removed from the coding rate adjusted sub band array 402 in order that the bandwidth associated with the specified audio signal bandwidth 208 is achieved. This mapping is given for each combination of audio signal bandwidth 208 and coding rate adjusted sub count array 402. The values specified by Table 3 are in terms of the number of sub bands removed, starting from the highest sub band in the coding rate adjusted sub band array 402

TABLE 3

| | Nos of | Number of high frequency sub | | | | |
|---|---|---|---|---|---|---|
| Audio signal | Freq | bands to remove from the coding | | | | |
| bandwidth/Sampling | bins/sb | rate adjusted sub band array | | | | |
| Frequency (Hz) | number | 5 sb | 8 sb | 12 sb | 18 sb | 24 sb |
| NB (8 kHz) Narrow Band | 10/10 | 1 | 2 | 4 | 8 | 14 |
| WB (16 kHz) Wide Band | 20/20 | — | 1 | 2 | 4 | 4 |
| SWB (32 kHz) Super Wide | 40/23 | — | — | — | 1 | 1 |
| Band | | | | | | |
| FB (48 kHz) Full Band | 60/24 | — | — | — | — | — |

An understanding of the operating mechanism of the bandwidth adjustment Table 3 may be further enhanced by taking the above example in which the number of sub bands was adjusted from 24 sb to 12 sb due to an IVAS coding rate of 160 kbps. In other words, the coding rate adjusted sub band array comprises 12 frequency sub bands for a coding rate of 160 kpbs. The coding rate adjusted sub band array having 12 sb then forms one input to the table, the other input is the bandwidth as specified by the audio signal bandwidth 208. Therefore, for an example input audio signal bandwidth 208 of Wide band (WB) mode the table will yield an adjustment factor of 2 sb. That is the two highest frequency sub bands are removed from the coding rate adjusted sub band array, giving a bandwidth adjusted sub band array 404 of 10 sb for the combination of an IVAS coding rate of 160 kbps with a selected bandwidth of WB. Overall, therefore, a 160 kbps overall (IVAS) coding rate (206) with an audio signal bandwidth (208) of WB will yield a bandwidth adjusted sub band array 404 having the first 10 sub bands which are spread over the 8 kHz bandwidth (16 kHz sampling frequency) of the wideband audio signal.

In addition to the adjustments resulting from the overall coding rate 206 and audio signal bandwidth 208, the width of the final frequency band for some combinations of coding rate adjusted sub bands 402 and audio signal bandwidth 208 may also be considered for further adjustment. The further adjustment may be applied for those cases of the bandwidth adjusted sub bands (as indicated by the bandwidth adjusted sub band array 404) in which the remaining highest frequency sub band is found to extend further than the bandwidth associated with the audio signal bandwidth 208.

This final adjustment process is shown in FIG. 4 as being performed by the highest sub band limiter 405, in which the highest sub band limiter 405 receives the bandwidth adjusted sub band array 404 together with the audio signal bandwidth 208 and produces as output the adjusted sub band configuration array 302.

In this respect, Table 3 above discloses the bandwidth in terms of the number of frequency bins for each possible value of audio signal bandwidth 208. Also shown in the same column in Table 3 is the bandwidth in terms of the sub band number of the 24 sub bands of the original time-frequency audio signals 202. This column may then be used to determine whether the final sub band of the bandwidth adjusted sub band array 404 extends further than the actual bandwidth allowed for by the audio signal bandwidth 208.

For example, from the above tables the narrow band signal (NB) can have a maximum signal bandwidth of 10 frequency bins, and the full band signal (FB) can have a maximum signal bandwidth of 60 frequency bins. As explained above, in some situations the highest sub band of the bandwidth adjusted sub band array 404 may extend beyond the actual bandwidth of the audio signal bandwidth (parameter) 208. This situation may be especially prevalent for the NB (narrow band) signal which has only an actual bandwidth of 10 frequency bins. For instance, if one inspects the MASA_band_grouping_24_to_12, which is the adjustment made to the number of sub bands for an overall coding rate of 160 kbps, the highest sub band has been allocated the frequency bins corresponding to the sub bands 22 to 24 (frequency bins 40 to 60) of the original time-frequency audio signals 202. If this coding rate is then further adjusted for a narrow band signal (NB) it can be seen from Table 3 that the four highest bands are removed leaving the following sub bands {0, 1, 2, 3, 4, 5, 7, 9, 12}. The final sub band occupies the frequency sub bands of 9 to 12 with respect to the sub bands of the MASA_band_grouping_24 array. Therefore, the final sub band in this instance will extend beyond the bandwidth of the NB signal of the 10^{th} frequency bin. Obviously, in these circumstances it would be advantageous to perform a further adjustment in which the final sub band is clipped to fall within the actual bandwidth of the audio signal bandwidth 208. In this regard, Table 4 below lists the respective sub band borders for each combination of audio signal bandwidth 208 and coding rate adjusted sub band array 402. It may be seen that some of the entries in Table 4 have had the frequency bins of highest sub band clipped to fall within the bandwidth of the audio signal bandwidth (parameter) 208. These entries have been marked with an Asterix* for clarity.

In embodiments, once the “pattern” of sub band borders (which is shown as the bandwidth adjusted sub band array 404 in FIG. 4) has been determined in response to the overall (IVAS) coding rate 206 (given by Table 2) and the bandwidth of the audio signal bandwidth input 208 (given by Table 3). The sub band borders of the bandwidth adjusted sub band array 404 may be further checked against Table 4 to determine whether the highest sub band is to be capped (or limited) to bring it into alignment with the actual bandwidth of the audio signal bandwidth 208.

TABLE 4

| | Initial | Adjusted | |
|---|---|---|---|
| Signal | number of | number of | |
| band- | subbands | subbands | Subbands borders in terms of the sub |
| width | # | # | band number of the full band signal |
| NB | 5 | 4 | {0, 1, 3, 7, 10} * |
| | 8 | 6 | {0, 1, 2, 3, 5, 8, 10}* |
| | 12 | 8 | {0, 1, 2, 3, 4, 5, 7, 9, 10}* |
| | 18 | 10 | {0, 1, 2, 3, 4, 5, 6, 7, 8, 9, 10} |
| | 24 | 10 | {0, 1, 2, 3, 4, 5, 6, 7, 8, 9, 10} |
| WB | 5 | 5 | {0, 1, 3, 7, 15, 20}* |
| | 8 | 7 | {0, 1, 2, 3, 5, 8, 12, 20} |
| | 12 | 10 | {0, 1, 2, 3, 4, 5, 7, 9, 12, 15, 20} |
| | 18 | 14 | {0, 1, 2, 3, 4, 5, 6, 7, 8, 9, 10, 12, 14, |
| | | | 17, 20} |
| | 24 | 20 | {0, 1, 2, 3, 4, 5, 6, 7, 8, 9, 10, 11, 12, |
| | | | 13, 14, 15, 16, 17, 18, 19, 20} |
| SWB | 5 | 5 | {0, 1, 3, 7, 15, 23}* |
| | 8 | 8 | {0, 1, 2, 3, 5, 8, 12, 20, 23}* |
| | 12 | 12 | {0, 1, 2, 3, 4, 5, 7, 9, 12, 15, 20, 22, |
| | | | 23}* |
| | 18 | 17 | {0, 1, 2, 3, 4, 5, 6, 7, 8, 9, 10, 12, 14, |
| | | | 17, 20, 21, 22, 23} |
| | 24 | 23 | {0, 1, 2, 3, 4, 5, 6, 7, 8, 9, 10, 11, 12, |
| | | | 13, 14, 15, 16, 17, 18, 19, 20, 21, |
| | | | 22, 23} |

In Table 4 the “number of sub bands” are the initial number of sub bands before adjustments are made on account of the overall (IVAS) coding rate 206 and audio signal bandwidth 208. Note the sub band borders are given in terms of the sub band count of the 24 sub bands of the time-frequency audio signals 202, in other words the sub band borders are with respect to the original MASA_band_grouping_24. For example, a full band signal which is reduced to 5 sub bands has a mapping according to MASA_band_mapping 24_to_5, where it can be seen that the final sub band occupies the sub bands (of the original audio signal of 24 sub bands) 15 to 24, this equates to the highest sub band occupying the frequency bins from 15 to 60. Clearly the bandwidth for a 32 kHz SWB signal is 16 kHz (or a sub band count of 23 in terms of the 24 sub bands time-frequency audio signals 202) which equates to the frequency bin width from 30 to 40 from the MASA_band_grouping_24 array (i.e. 12 kHz to 16 kHz). Therefore, the mapping from 24 sub bands to 5 sub bands for SWB signal is capped at a sub band count of 23 (which is equivalent to the frequency bin count of 40 according to the array MASA_band_grouping_24), to ensure that the signal does not extend beyond the bandwidth of the SWB signal (16 kHz).

The output from the highest sub band limiter 405 is the adjusted sub band configuration array 302. In instances of when the highest sub band of the bandwidth sub band array 404 falls within the bandwidth of the audio bandwidth 208 the adjusted sub band configuration array 302 will be the bandwidth adjusted sub band array 404. In other words, there is no limiting/capping operation applied to the highest sub band. However, in instances of when the highest sub band of the bandwidth sub band array 404 extends further than the bandwidth of the audio signal bandwidth 208. The adjusted sub band configuration array 302 will be the bandwidth adjusted sub band array 404 in which the highest sub band is limited in terms of its width.

The adjusted sub band configuration array 302 may then be passed to the parameter set merger/reducer 305 as shown in FIG. 3.

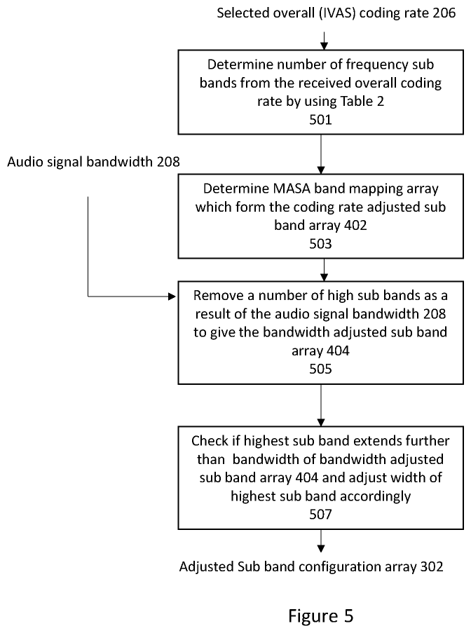

FIG. 5 depicts a computer software or hardware implementable process of the frequency sub band adjuster 303 for the determination of the adjusted sub band configuration array 302. The adjusted sub band configuration array 302 is shown as being determined from the overall (IVAS) coding rate 206 and the audio signal bandwidth 208. To be clear, in embodiments the adjusted sub band configuration array 302 (or vector) may comprise member values which specify the borders of the sub bands for the parameter set merger/reducer 305. In effect the adjusted sub band configuration array 302 can be one of the sub band border arrays from Table 4 above. The parameter set merger/reducer 305 then use the adjusted sub band configuration array 302 to merge neighbouring sets of spatial audio parameters from neighbouring sub bands. The parameter set merger/reducer 305 can also be arranged to remove spatial audio parameter sets which correspond to frequency sub bands greater than those of the adjusted sub band configuration array 302. The results of the merging and reduction processes are sets of spatial audio parameters for sub bands which mirror the pattern of sub bands as given by the adjusted sub band configuration array 302. In some embodiments, the adjusted sub band configuration array 302 may be arranged as an index or pointer to one of the sub band border arrays of Table 4.

Returning to FIG. 5, the process of determining the adjusted sub band configuration array 302 by the frequency sub band adjuster 303 is shown as receiving the input 206 comprising an indication of the overall coding rate (for the IVAS encoder). The processing step 501 depicts the mapping step between the received overall (IVAS) coding rate 206 and the number of frequency sub bands allowed in the coding rate adjusted sub band array 402. This can be performed by using Table 2.

Processing step 503 in FIG. 5 depicts the selection of the MASA_band_mapping array as determined by the number of frequency sub bands from the step 501. Note the higher coding rates from Table 2 do not require a reduction in the number of sub bands. The selected MASA_band_mapping array forms the coding rate adjusted sub band array 402.

Processing step 505 in FIG. 5 depicts the step of removing a number of high frequency sub bands from the coding rate sub band array 402 in response to the audio signal bandwidth 208. This step may be implemented, for instance, by using Table 3.

Processing step 507 depicts the process of checking Table 4 to determine whether the highest sub band of the bandwidth adjusted sub band array 404 extends further than the bandwidth of the audio signal sampling frequency 208. If the highest sub band extends further than the bandwidth, then adjust the width of the highest sub band to lie within the bandwidth. This step can be performed by using Table 4. The output from this step may be one of the arrays from Table 4 which specifies the sub band borders of the adjusted sub band configuration array 302.

The processing steps according to FIG. 5 have the advantage that no extra signalling bits are required to be sent from encoder to decoder. The reason being that the decoder can be made aware of both the coding rate and bandwidth at the encoder through system level configuration information in conjunction with encoder and decoder both having access to the above tables.

It is to be appreciated that FIG. 3 in conjunction with FIG. 4 shows that the spatial parameter sets associated with the original pattern of sub bands of the time frequency audio signals 202 are merged and reduced as a final stage, in accordance with the pattern of sub bands given by the adjusted sub band configuration array 302. In other words, the merging of spatial audio parameter sets as indicated by the coding rate adjusted sub band array 402, the reduction of spatial parameter sets as indicated by bandwidth adjusted sub band array 404 and the conditional trimming of the highest sub bands as depicted by 405 may occur as a single processing stage in accordance with the “final” adjusted sub band configuration array 302 in the parameter set merger/reducer 305.

However, it is also to be appreciated in other embodiments the process of spatial parameter set merging and reduction may occur in sequence at the point when respective pattern of sub bands is determined. Therefore, in these embodiments the merging of sub bands parameter sets may be performed when the coding rate adjusted sub band array 402 is determined. This step may then be followed by the reduction of spatial parameter sets when the bandwidth adjusted sub band array 404 is determined. Finally, the spatial parameter sets of the highest frequency sub bands may then be conditionally trimmed by the highest sub band limiter 405.

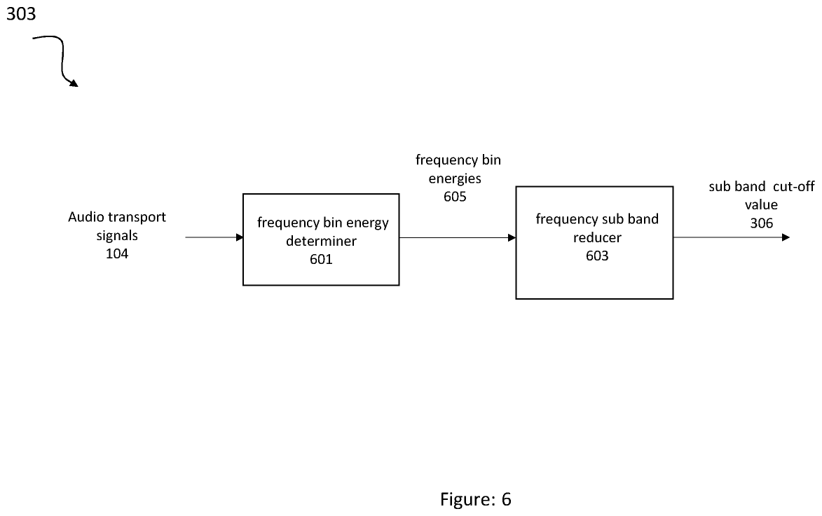

FIG. 6 shows the frequency sub band adjuster 303 for embodiments which deploy a sub band cut off signal 306 as from the energy levels of the sub bands of the audio transport signal 104.

In FIG. 6, the sub band adjuster 303 is shown as receiving the audio transport signal 104 by the frequency bin energy determiner 601. The frequency bin energy determiner 601 is configured to measure/determine the energy of the audio signal in each frequency bin of the audio transport signal 104, in other words the frequency bin energies 605. Bearing in mind that the audio transport signal 104 can comprise up to two transport signals, the frequency bin energy determiner 601 is arranged to determine the energy in each frequency bin for all the transport signals. The energy calculation may be performed on per audio frame basis.

The output of the frequency bin energy determiner 601, the frequency bin energies 605 (for each transport signal) are then passed to the frequency sub band reducer 603 for further processing.

The frequency sub band reducer 603 may be arranged to determine whether any of the frequency bin energies are below a pre-determined energy. This may be performed by scanning the energy of each frequency bin in a decreasing order of frequency bin index of the frequency bin energies signal 605 and checking for the first instance of when the energy of the frequency bin is above a minimum energy level. Upon determining such an index bₘ the energy cut off frequency bin index be can be determined as bₘ+1. The frequency sub band reducer 603 may then be configured to determine the frequency sub band kₑ in which the frequency bin index be lies. This is determined to be the cut off frequency sub band above which the audio transport signal 104 is considered to have a negligible contribution to the final multi-channel spatial audio signal 110. In other words, any sub bands above having an index of kₑ and above are deemed to have an insufficient energy level, and therefore spatial parameter sets associated with these sub bands can be effectively removed by not being encoded.

With respect to the instance when the audio transport signal 104 has more than one channel. The above process may be performed for each channel in turn such that multiple frequency bin indexes (bₑ₁, bₑ₂ . . . ) may be found (one for each channel.) The highest frequency bin index is selected, and the frequency sub band associated with the highest frequency bin index can be determined as the cut off frequency sub band index kₑ for all channels of the audio transport signal 104.

The cut off frequency sub band index kₑ may be communicated to the parameter set merger/reducer 305 as the signal 306. kₑ>B_{W}(k)

$${k}_{e} < {B}_{W} ( k )$$

When the parameter set merger/reducer 305 receives the signal 306, it may be arranged to remove all the spatial parameter sets associated with all frequency sub bands kₑ and above. That is all parameter sets associated with frequency sub bands kₑ to K−1 (where K−1 is the highest sub band index associated with the audio transport signal 104) are set to zero (or removed) and therefore will not form part of the spatial metadata signal 106 being passed to the metadata encoder/quantizer 111.

The remaining spatial parameter sets of the spatial audio metadata 106 may then be encoded by the spatial parameter set encoder 207 by techniques described in patent application EP3818525. Further, the spatial parameter set encoder 207 may also be arranged to encode the number of sub bands which do not contain encoded spatial parameter sets (the number of sub bands from kₑ to K−1) using a Golomb Rice code of order zero.

It is to be noted that for the case of when all frequency bins have an energy level above the pre-determined energy level then there are no spatial parameter sets removed from the spatial metadata signal 106. This case can be signalled using a single bit.

Therefore, in this embodiment, the encoded spatial metadata information can comprise the encoded spatial parameter sets and an additional signalling bit. Where one state of the signalling bit indicates the encoded spatial metadata 106 comprise encoded spatial audio parameter sets for all frequency bands and the other state of the signalling bit indicates that a partial number of frequency band spatial parameter sets of the spatial metadata 106 have been encoded.

In another embodiment the spatial parameter set encoder 207 may be arranged to do away with the single bit indicating that there are no spatial parameter sets removed from the spatial metadata signal 106. Instead, a single bit is only added to the encoded stream in a particular instance of when the number of sub band spatial parameter sets is less than the full number of sub bands and the direct-to-total energy ratio of the spatial audio parameter set associated with the sub bands kₑ to K−1 (the remaining sub bands) are quantised to the smallest quantisation level.

It should be noted that the quantisation and encoding of an energy ratio value can be performed separately from the quantisation and encoding of the other spatial audio parameters of the sub band spatial audio parameter set. Therefore, each sub band can have at least a quantised energy ratio associated with it. Whereas the other parameters of the spatial audio parameters set associated with the sub band need not be quantised and encoded (and therefore not forming part of the encoded bit stream).

For example, the energy ratio value (for each sub band) may be quantized with a 3-bit scalar quantizer, and the quantization and encoding of the other spatial audio parameters of the spatial audio parameter set for a sub band may be quantised and encoded according to the publication EP3818525.

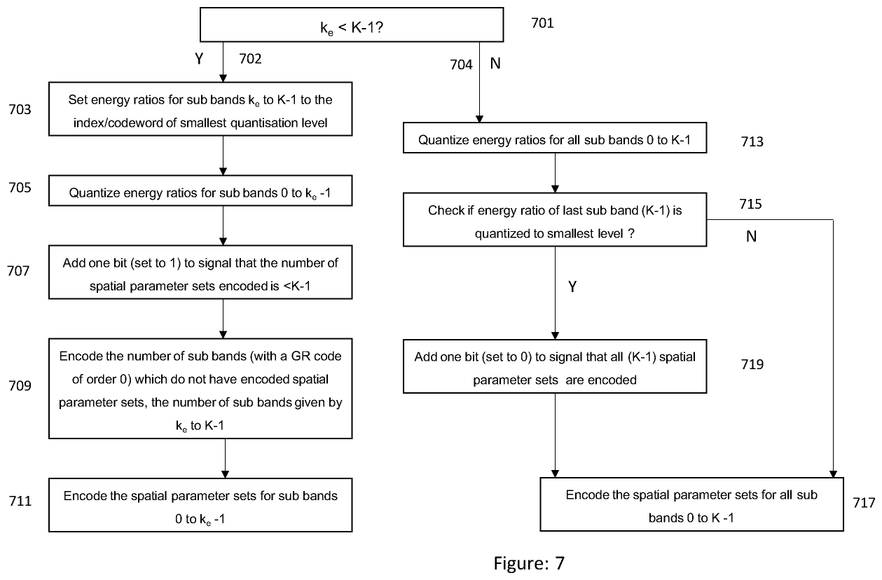

With respect to the other embodiment, FIG. 7 depicts a further process of quantizing sub band spatial parameter sets when sub bands of the audio transport signal 104 are deemed to have a low enough energy as not to contribute to the synthesised multi-channel spatial audio signal 110.

As seen in FIG. 7 the process commences by receiving the value of kₑ in relation to the K−1 frequency sub bands of a sub frame.

Initially the cut of sub band value of kₑ is inspected to determine if kₑ<K−1. As mentioned above this indicates that the spatial audio parameter sets for frequency sub bands kₑ to K−1 can be removed from the metadata encoding process performed by 111. This is shown in FIG. 7 by the processing step of 701.

If at step 701 it is determined that kₑ<K−1 then the processing path 702 is taken according to FIG. 7.

The process path 702 then sets the energy ratios associated with the frequency sub bands kₑ<K−1 to have the smallest quantization level. This is shown as the processing step 703 in FIG. 7.

The energy ratios associated with the frequency sub bands 0 to kₑ−1 are then quantized according to their values. As mentioned above this may be performed with a scalar quantizer, thereby producing a quantization index (or codeword) for each energy ratio value. This is shown as the processing step 705 in FIG. 7.

A single bit may then be appended to the bit stream (for the subframe) to indicate that the number of encoded spatial audio parameter sets encoded in the bit stream for the sub frame is not the full complement for sub bands K−1. This is shown in as processing step 707 in FIG. 7.

The number of frequency sub bands which do not have any associated spatial parameter sets, that is the sub bands kₑ<K−1 are encoded using a Golomb Rice code of order 0. This is shown as the processing step 709 in FIG. 7. Obviously, this encoded number of frequency sub bands also forms part of the encoded bit stream for the frame.

Finally, the “other” spatial audio parameters of the spatial audio parameter sets for the sub bands 0 to kₑ−1 may be quantised and encoded according to the publications WO2022/129672, WO2021/048468, WO2020/070377, WO2020/008105 and WO2021/144498. As above, these quantised spatial audio parameter sets may also form part of the encoded bitstream for the frame. This step is shown as the processing step 711 in Figure.

Note to be clear the term “other” spatial audio parameters in this context refers to the spatial audio parameters of a spatial audio parameter set (for a sub band) which does not comprise the above energy ratio.

Returning to the determining step 701 in FIG. 7, it can be seen if the result of this step determines that all frequency sub bands are to have their respective spatial parameter sets encoded. In other words, the frequency sub band reducer 603 effectively determines that all sub bands are above the minimum energy level by at least one means of returning a value of kₑ=K−1. It is to be understood that a skilled person would appreciate that other means may be used to signal this condition. The process may then be arranged to take the processing path 704.

Once the decision is made to take the processing path 704, the parameter set merger/reducer 305 can be arranged to quantize and encode the energy rations corresponding to all frequency sub bands 0 to K−1. This is shown as processing step 713 in FIG. 7.

The process then determines whether the energy ratio associated with the last sub band (K−1) has been quantized to the smallest quantized level. This decision step is shown as the processing step of 715 in FIG. 7. When the result of the decision step 715 indicates that the energy ratio associated with the last sub band (K−1) has not been quantized to the smallest quantization level the process is arranged to proceed to processing step 717 where the spatial parameter sets associated with all sub bands 0 to K−1 are quantized and encoded.

However, when the decision step 715 indicates that the energy ratio associated with the last sub band (K−1) has been quantized to the smallest quantized level the process is arranged to proceed to processing step 719. At processing step 719 a single bit is appended to the encoded stream (for the frame). The state of the bit (shown as set to 0 in FIG. 7) indicates that all K−1 spatial parameter sets have been encoded despite the energy ratio associated with the final sub band K−1 being encoded to the smallest quantization level.

Finally, after step 719, FIG. 7 shows the process moving to the processing step 717, whereas before the spatial parameter sets associated with all sub bands 0 to K−1 are quantized and encoded.

To be clear, the bit stream for the processing route 702 may at least comprise for each frame the encoded and quantised energy ratios associated with frequency bands 0 to kₑ−1, the energy ratios associated with sub bands kₑ to K−1 quantized and encoded to the smallest quantization level, a bit to signal that the number of spatial parameter sets encoded is <K−1, GR code of order zero indicating the number of sub bands given by the value of kₑ to K−1, and the quantized and encoded spatial parameter sets (each comprising other spatial parameters to the energy ratio) associated with the sub bands 0 to kₑ−1.

Following on from above, the bit stream for the processing route 704 may at least comprise for each frame the encoded and quantised energy ratios associated with frequency bands 0 to K−1 and the quantized and encoded spatial parameter sets (each comprising other spatial parameters to the energy ratio) associated with the sub bands 0 to K−1. Additionally, the bit stream for the processing route 704 can also comprise a bit to signal that the number of spatial parameter sets encoded corresponds to the sub bands from 0 to K−1 for the circumstance of when the energy ratio associated with the last frequency band K−1 is quantized to a minimum level.

The above embodiments may be performed on a per frame basis. Further the second embodiment may be deployed in conjunction with the first embodiment on a frame-by-frame basis. For instance, the decision whether to use the first embodiment or the second embodiment may be taken at the start of a new frame.

It is to be appreciated in some further embodiments the above energy-based embodiments can be performed in conjunction with the earlier embodiments employing the processing steps according to FIG. 5. In other words, the above energy-based embodiments may be integrated into embodiments where the spatial parameter sets associated with the sub bands of the time-frequency audio signals 202 are merged and reduced in response to the overall coding rate 206 and audio signal bandwidth 208.

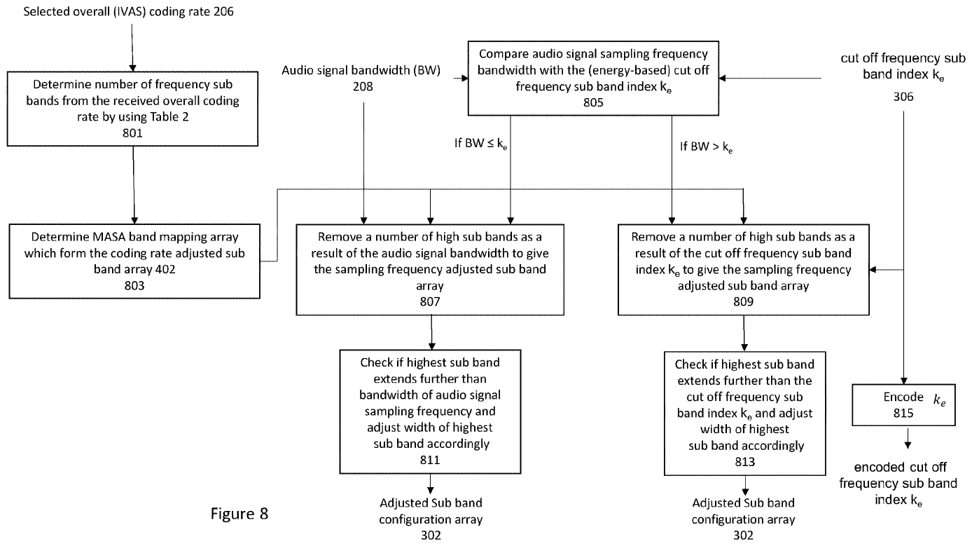

In this respect FIG. 8 shows how the above energy-based embodiments may be implemented in a system deploying the earlier embodiments according to FIG. 5.

The processing steps 801 and 803 may be arranged as in FIG. 5 where the selected overall (IVAS) coding rate 206 is received and on this basis the coding rate adjusted sub band array 402 may by determining the MASA band mapping array.

Processing step 803 and be arranged to receive a bandwidth B_{W} which is the specified audio signal bandwidth 208. This can be given for instance by Table 3 where the various allowable sampling frequencies are listed as a function of the number of sub bands k.

The processing step 805 then compares the audio signal bandwidth B_{W} 208 against the cut off frequency sub band index kₑ 306.

FIG. 8 then goes onto show that when the cut off frequency sub band index kₑ is found to be greater than (or equal to) the bandwidth B_{W} the process proceeds to step 807 in which a similar processing step to that of step 505 is performed. In other words, processing step 807 performs the process of removing high frequency sub bands from the coding rate sub band array 402 in response to the audio signal bandwidth 208 B_{W}. Accordingly, processing step 807 is shown as also receiving the coding rate adjusted sub band array 402 from processing step 803 and the audio signal bandwidth 208. The outcome of this processing step is therefore the bandwidth adjusted sub band array 404.

Alternatively, comparison step 803 may determine that the energy based cut off frequency sub band index kₑ is less than the bandwidth B_{W}. When this condition is met, the process can be arranged to transition to step 809. At step 809 the process is arranged to remove frequency sub bands which are above the cut off frequency sub with index kₑ. In other words, processing step 809 takes the coding rate adjusted sub band array 402 and removes those sub bands whose indices lie above the cut off index kₑ. Therefore, the result of this processing step may be viewed as a version of the bandwidth adjusted sub band array 404, in which the higher sub bands are limited according to the cut off index 306. Accordingly, the processing step 809 is shown as also receiving the coding rate adjusted sub band array 402 from processing step 803 and the cut off frequency sub band index kₑ 306 thereby allowing the above variant of the bandwidth adjusted sub band array 404 to be formed.

FIG. 8 depicts the output from step 807 (the bandwidth adjusted sub band array 404) being passed to processing step 811. Step 811 performs a similar processing function as step 505 in FIG. 5. In other words, step 811 performs the process of determining whether the highest sub band of the bandwidth adjusted sub band array 404 extends further than the audio signal bandwidth 208, and if the highest sub band is found to extend further than the audio signal bandwidth 208, then the width of the highest sub band is adjusted to lie within this bandwidth. The output from step 811 is the adjusted sub band configuration array 302.

Processing step 813 is shown as accepting the bandwidth adjusted sub band array 404 from step 809. In a similar manner to that of step 811, processing step 813 can be arranged to perform the process of determining whether the highest sub band of the bandwidth adjusted sub band array 404 extends further that the cut off frequency sub band with index kₑ 306. If it is determined that this is indeed the case, then the width of the highest sub band is adjusted to lie within the bandwidth of the cut off frequency sub band index kₑ 306. The output from step 813 is also a further variant of the adjusted sub band configuration array 302.

Furthermore, FIG. 8 also shows that the cut off frequency sub band index kₑ 306 may be encoded when the processing path 805 is followed. This is shown as processing step 815 where the encoding of the cut off frequency sub band index kₑ 306 may be performed according to the processing steps of FIG. 7.

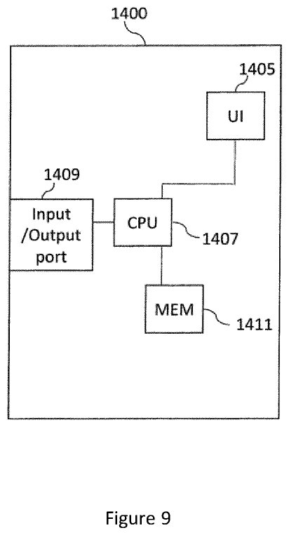

With respect to FIG. 9 an example electronic device which may be used as the analysis or synthesis device is shown. The device may be any suitable electronics device or apparatus. For example, in some embodiments the device 1400 is a mobile device, user equipment, tablet computer, computer, audio playback apparatus, etc.

In some embodiments the device 1400 comprises at least one processor or central processing unit 1407. The processor 1407 can be configured to execute various program codes such as the methods such as described herein.

In some embodiments the device 1400 comprises a memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore, in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example, the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating with the position determiner as described herein.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example, in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1409 may be configured to receive the signals and in some embodiments determine the parameters as described herein by using the processor 1407 executing suitable code. Furthermore, the device may generate a suitable downmix signal and parameter output to be transmitted to the synthesis device.

In some embodiments the device 1400 may be employed as at least part of the synthesis device. As such the input/output port 1409 may be configured to receive the downmix signals and in some embodiments the parameters determined at the capture device or processing device as described herein and generate a suitable audio signal format output by using the processor 1407 executing suitable code. The input/output port 1409 may be coupled to any suitable audio output for example to a multichannel speaker system and/or headphones or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs can route conductors and locate components on a semiconductor chip using well established rules of design as well as libraries of pre-stored design modules. Once the design for a semiconductor circuit has been completed, the resultant design, in a standardized electronic format may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising: at least one processor; and at least one memory storing instructions that, when executed by the at least one processor, cause the apparatus at least to:
determine a spatial audio parameter set for each of a plurality of frequency sub bands of one or more audio signals;
receive a coding rate associated with the one or more audio signals;
map at least two consecutive sub bands of the plurality of frequency sub bands to a broadened frequency sub band to give a coding rate adjusted plurality of frequency sub bands based on the coding rate;
receive a bandwidth value associated with the one or more audio signals;
remove, starting from the highest frequency sub band of the coding rate adjusted plurality of frequency sub bands, a number of frequency sub bands to give a bandwidth adjusted plurality of frequency sub bands, wherein the number of frequency sub bands removed is based on the bandwidth value associated with the one or more audio signals;
on condition that a highest frequency sub band of the bandwidth adjusted plurality of frequency sub bands extends beyond the bandwidth value associated with the one or more audio signals, reduce the highest frequency sub band of the bandwidth adjusted plurality of frequency sub bands to lie on or below the bandwidth value;
merge a spatial audio parameter set associated with the first of the at least two consecutive frequency sub bands with a spatial audio parameter set associated with the second of the at least consecutive two frequency sub bands to give a merged spatial audio parameter set for the broadened frequency sub band;
remove a spatial audio parameter set corresponding to each removed frequency sub band; and
on the condition that the highest frequency sub band of the bandwidth adjusted plurality of frequency sub bands extends beyond the bandwidth value remove spatial audio parameter sets associated with the bandwidth adjusted plurality of frequency sub bands which extend beyond the bandwidth value.

2. The apparatus as claimed in claim 1, wherein the highest frequency sub band of the bandwidth adjusted plurality of frequency sub bands comprises an upper sub band border value and a lower sub band border value encompassing a plurality of the plurality of frequency sub bands of the one or more audio signals, and wherein the apparatus caused to reduce the highest frequency sub band of the bandwidth adjusted plurality of frequency sub bands to lie on or below the bandwidth value is caused to:
adjust the upper sub band border value to lie within the bandwidth value; and wherein the apparatus caused to remove spatial audio parameter sets associated with the bandwidth adjusted plurality of frequency sub bands which extend beyond the bandwidth value is caused to remove spatial audio parameter sets associated with the plurality of the plurality of frequency sub bands of the one or more audio signals which are above the adjusted upper sub band border value.

3. The apparatus as claimed in claim 1, wherein the apparatus caused to map at least two consecutive sub bands of the plurality of frequency sub bands to a broadened frequency sub band to give the coding rate adjusted plurality of frequency sub bands based on the coding rate, is caused to:
map a higher frequency band border value and a lower frequency band border value for the at least two consecutive frequency sub bands of the plurality of frequency sub bands to a lower frequency band border value and a higher frequency band border value of the broadened frequency sub band.

4. The apparatus as claimed in claim 3, wherein the lower frequency sub band border value and the higher frequency sub band border value of the broadened frequency sub band is given by a lower frequency band border value and a higher frequency band border value of a frequency sub band reduction array comprising a plurality of frequency sub band borders in increasing order of frequency sub bands, wherein a sub band border value and a next higher sub band border value in increasing order of the frequency sub band reduction array are the lower frequency sub band border and the higher frequency sub band border respectively of the broadened frequency sub band.

5. The apparatus as claimed in claim 4, wherein the plurality of frequency sub band borders in the frequency sub band reduction array constitutes fewer frequency sub bands than the plurality of frequency sub bands of the one or more audio signals, and wherein the coding rate adjusted plurality of frequency sub bands is given by the frequency sub band reduction array, wherein the frequency sub band reduction array is selected from a plurality of frequency sub band reduction arrays, wherein the selection is based on the coding rate associated with the one or more audio signals, and wherein each of the plurality of frequency sub band reduction arrays comprise a different number of frequency sub bands, and wherein each of the plurality of frequency sub band reduction arrays is associated with a different coding rate associated with the one or more audio signals.

6. The apparatus as claimed in claim 1, wherein the number of frequency sub bands to be removed is selected from a plurality of number of frequency sub bands to be removed, wherein the selection is based on the bandwidth value, and wherein each of the plurality of number of frequency sub bands to be removed is associated with a different bandwidth value.

7. The apparatus as claimed in claim 1, wherein the sampling frequency adjusted plurality of frequency sub bands is in the form of an array comprising a plurality of frequency sub band border values in increasing order of frequency sub bands.

8. The apparatus as claimed in claim 1, wherein the apparatus comprises a first encoder and second encoder for encoding the one or more audio signals at the coding rate, wherein the coding rate comprises the sum of an encoding rate for the first encoder and an encoding rate for the second encoder, wherein the first encoder encodes an audio transport signal associated with the one or more audio signals, and the second encoder encodes the plurality of spatial audio parameter sets associated with the frequency sub bands of the one or more audio signals.

9. An apparatus comprising: at least one processor; and at least one memory storing instructions that, when executed by the at least one processor, cause the apparatus at least to:
determine a spatial audio parameter set for each of a plurality of frequency sub bands of one or more audio signals;
receive a coding rate associated with the one or more audio signals;
map at least two consecutive sub bands of the plurality of frequency sub bands to a broadened frequency sub band to give a coding rate adjusted plurality of frequency sub bands based on the coding rate;
merge a spatial audio parameter set associated with the first of the at least two consecutive frequency sub bands with a spatial audio parameter set associated with the second of the at least consecutive two frequency sub bands to give a merged spatial audio parameter set for the broadened frequency sub band;
determine an energy level for each frequency bin of the one or more audio signals;
determine a cut off frequency sub band for the one or more audio signals by determining a highest frequency bin which has an energy level greater than a predetermined energy level and assigning the cut off frequency sub band as a frequency sub band which incorporates the highest frequency bin;
compare the cut off frequency sub band for the one or more audio signals to a bandwidth value for the one or more audio signals;
on condition of the cut off frequency sub band being less than the bandwidth value for the one or more audio signals remove, starting from the highest frequency sub band of the coding rate adjusted plurality of frequency sub bands, a number of frequency sub bands to give a bandwidth adjusted plurality of frequency sub bands, wherein the number of frequency sub bands removed is based on the cut off frequency sub band and remove a spatial audio parameter set corresponding to each removed frequency sub band;
on condition that a highest frequency sub band of the bandwidth adjusted plurality of frequency sub bands extends beyond the cut off frequency sub band, reduce the highest frequency sub band of the bandwidth adjusted plurality of frequency sub bands to lie on or below the cut off frequency sub band value and remove spatial audio parameter sets associated with the bandwidth adjusted plurality of frequency sub bands which extend beyond the cut off frequency sub band; and
encode the index of the cut off frequency sub band.

10. The apparatus as claimed in claim 9, wherein the apparatus caused to encode the index of the cut off frequency sub band is further caused to encode each spatial audio parameter set associated with the frequency sub bands below the cut off frequency sub band.

11. The apparatus as claimed in claim 10, wherein the apparatus caused to encode each spatial audio parameter set associated with the frequency sub bands below the cut off frequency sub band is caused to:
determine an energy ratio parameter for each of the plurality of frequency sub bands of the one or more audio signals;
quantize the energy ratio for each frequency sub band of the plurality of frequency sub bands which is greater than or equal to the cut off frequency band to a smallest quantization level;
quantize the energy ratio for each frequency sub band of the plurality of frequency sub bands which is less than the cut off frequency band; and
encode an indication that the number of spatial audio parameter sets encoded is less than the number of frequency sub bands of the one or more audio signals; and
encode the number of spatial audio parameter sets which are not encoded using a Golomb Rice code.

12. The apparatus as claimed in claim 9, wherein the highest frequency sub band of the bandwidth adjusted plurality of frequency sub bands comprises an upper sub band border value and a lower sub band border value encompassing a plurality of the plurality of frequency sub bands of the one or more audio signals, and wherein the apparatus caused to reduce the highest frequency sub band of the bandwidth adjusted plurality of frequency sub bands to lie on or below the cut off frequency sub band value and remove spatial audio parameter sets associated with the bandwidth adjusted plurality of frequency sub bands which extend beyond the cut off frequency sub band is caused to:
adjust the upper sub band border value to lie within the cut off frequency sub band value; and
remove spatial audio parameter sets associated with the plurality of the plurality of frequency sub bands of the one or more audio signals which are above the adjusted upper sub band border value.

13. The apparatus as claimed in claim 9, wherein the apparatus caused to map at least two consecutive sub bands of the plurality of frequency sub bands to a broadened frequency sub band to give the coding rate adjusted plurality of frequency sub bands based on the coding rate, is caused to:
map a higher frequency band border value and a lower frequency band border value for the at least two consecutive frequency sub bands of the plurality of frequency sub bands
to a lower frequency band border value and a higher frequency band border value of the broadened frequency sub band.

14. The apparatus as claimed in claim 13, wherein the lower frequency sub band border value and the higher frequency sub band border value of the broadened frequency sub band is given by a lower frequency band border value and a higher frequency band border value of a frequency sub band reduction array comprising a plurality of frequency sub band borders in increasing order of frequency sub bands, wherein a sub band border value and a next higher sub band border value in increasing order of the frequency sub band reduction array are the lower frequency sub band border and the higher frequency sub band border respectively of the broadened frequency sub band.

15. The apparatus as claimed in claim 14, wherein the plurality of frequency sub band borders in the frequency sub band reduction array constitutes fewer frequency sub bands than the plurality of frequency sub bands of the one or more audio signals, and wherein the coding rate adjusted plurality of frequency sub bands is given by the frequency sub band reduction array, wherein the frequency sub band reduction array is selected from a plurality of frequency sub band reduction arrays, wherein the selection is based on the coding rate associated with the one or more audio signals, and wherein each of the plurality of frequency sub band reduction arrays comprise a different number of frequency sub bands, and wherein each of the plurality of frequency sub band reduction arrays is associated with a different coding rate associated with the one or more audio signals.

16. The apparatus as claimed in claim 9, wherein the sampling frequency adjusted plurality of frequency sub bands is in the form of an array comprising a plurality of frequency sub band border values in increasing order of frequency sub bands.

17. The apparatus as claimed in claim 9, wherein the apparatus comprises a first encoder and second encoder for encoding the one or more audio signals at the coding rate, wherein the coding rate comprises the sum of an encoding rate for the first encoder and an encoding rate for the second encoder, wherein the first encoder encodes an audio transport signal associated with the one or more audio signals, and the second encoder encodes the plurality of spatial audio parameter sets associated with the frequency sub bands of the one or more audio signals.

18. A method comprising:
determining a spatial audio parameter set for each of a plurality of frequency sub bands of one or more audio signals;
receiving a coding rate associated with the one or more audio signals;
mapping at least two consecutive sub bands of the plurality of frequency sub bands to a broadened frequency sub band to give a coding rate adjusted plurality of frequency sub bands based on the coding rate;
receiving a bandwidth value associated with the one or more audio signals;
removing, starting from the highest frequency sub band of the coding rate adjusted plurality of frequency sub bands, a number of frequency sub bands to give a bandwidth adjusted plurality of frequency sub bands, wherein the number of frequency sub bands removed is based on the bandwidth value associated with the one or more audio signals;
on condition that a highest frequency sub band of the bandwidth adjusted plurality of frequency sub bands extends beyond the bandwidth value associated with the one or more audio signals, reducing the highest frequency sub band of the bandwidth adjusted plurality of frequency sub bands to lie on or below the bandwidth value;
merging a spatial audio parameter set associated with the first of the at least two consecutive frequency sub bands with a spatial audio parameter set associated with the second of the at least consecutive two frequency sub bands to give a merged spatial audio parameter set for the broadened frequency sub band;
removing a spatial audio parameter set corresponding to each removed frequency sub band; and
on the condition that the highest frequency sub band of the bandwidth adjusted plurality of frequency sub bands extends beyond the bandwidth value removing spatial audio parameter sets associated with the bandwidth adjusted plurality of frequency sub bands which extend beyond the bandwidth value.

19. A method
comprising:
determining a spatial audio parameter set for each of a plurality of frequency sub bands of the one or more audio signals;
receiving a coding rate associated with the one or more audio signals;
map at least two consecutive sub bands of the plurality of frequency sub bands to a broadened frequency sub band to give a coding rate adjusted plurality of frequency sub bands based on the coding rate;
merging a spatial audio parameter set associated with the first of the at least two consecutive frequency sub bands with a spatial audio parameter set associated with the second of the at least consecutive two frequency sub bands to give a merged spatial audio parameter set for the broadened frequency sub band;
determining an energy level for each frequency bin of the one or more audio signals;
determining a cut off frequency sub band for the one or more audio signals by determining a highest frequency bin which has an energy level greater than a predetermined energy level and assigning the cut off frequency sub band as a frequency sub band which incorporates the highest frequency bin;
comparing the cut off frequency sub band for the one or more audio signals to a bandwidth value for the one or more audio signals;
on condition of the cut off frequency sub band being less than the bandwidth value for the one or more audio signals removing, starting from the highest frequency sub band of the coding rate adjusted plurality of frequency sub bands, a number of frequency sub bands to give a bandwidth adjusted plurality of frequency sub bands, wherein the number of frequency sub bands removed is based on the cut off frequency sub band and remove a spatial audio parameter set corresponding to each removed frequency sub band;
on condition that a highest frequency sub band of the bandwidth adjusted plurality of frequency sub bands extends beyond the cut off frequency sub band, reducing the highest frequency sub band of the bandwidth adjusted plurality of frequency sub bands to lie on or below the cut off frequency sub band value and removing spatial audio parameter sets associated with the bandwidth adjusted plurality of frequency sub bands which extend beyond the cut off frequency sub band; and
encoding the index of the cut off frequency sub band.
